(19) United States
(12) Patent Application Publication
(10) Pub. No.: US 2013/0033739 A1
(43) Pub. Date: Feb. 7, 2013

(54) ELECTROVARIABLE NANOPLASMONICS AND SELF-ASSEMBLING SMART MIRRORS

(71) Applicants: Michael E. Flatté, Iowa City, IA (US); Alexei Kornyshev, London (GB); Michael Urbakh, Tel Aviv (IL)

(72) Inventors: Michael E. Flatté, Iowa City, IA (US); Alexei Kornyshev, London (GB); Michael Urbakh, Tel Aviv (IL)

(73) Assignees: UNIVERSITY OF IOWA RESEARCH FOUNDATION, Iowa City, IA (US); RAMOT AT TEL AVIV UNIVERSITY LTD., Tel Aviv (IL); IMPERIAL INNOVATIONS, London (GB)

(21) Appl. No.: 13/518,725

(22) PCT Filed: Dec. 22, 2010
(86) PCT No.: PCT/US10/61828

§ 371 Date: Oct. 18, 2012

Related U.S. Application Data
(60) Provisional application No. 61/290,054, filed on Dec. 24, 2009.

(51) Int. Cl. G02B 26/00; B82Y 20/00; B82B 1/00

(52) U.S. Cl. 359/291; 977/773; 977/932

(57) ABSTRACT

Systems and methods provide control of nanoparticle coverage of an interface between a first medium and a second medium through variation of an electric potential across such interface; the first medium and the second medium are immiscible media, and transparent or substantially transparent to visible light. The first medium can be a first electrolytic solution and the second medium can be a second electrolytic solution; thus, the interface can become an interface of two immiscible electrolytic solutions (ITIES). The nanoparticle coverage of the interface, e.g., the ITIES, can be regulated to vary between approximately zero and a full or nearly a full monolayer. The nanoparticle coverage of the interface can dictate at least one optical property of the interface, rendering the interface transparent or substantially transparent, or a mirror, or providing Faraday rotation of the optical polarization of light incident normal to the interface and propagating through the interface.

### CROSS-REFERENCE TO RELATED APPLICATIONS

The present application is a National Phase application of International Application No. PCT/US2010/061828, filed Dec. 22, 2010, which claims the benefit of U.S. Provisional Application No. 61/290,054, filed Dec. 24, 2009. Both of the above-captioned applications are incorporated herein in their entireties by this reference.

### NOTICE REGARDING FEDERAL FUNDING

This invention was made with government support under Grant No. W911NF-08-1-0317, awarded by the Department of Defense, Army Research Office/Multidisciplinary University Research Initiative. The government has certain rights in the invention.

### BACKGROUND

Nanoplasmonics is a rapidly developing area with many applications. Its electrodynamic foundation can be traced at least to Mie's work (G. Mie, Ann. Phys. 25, 377 (1908), incorporated herein by reference). It was further developed during an ‘optical renaissance’ of the late 1960s-early 1980s, and emerged from a deeper understanding of collective excitations at solid surfaces. During this time the interest was generally in the enhanced optical performance of finite size objects such as metallic spheres, ellipsoids or cylinders—implicitly of about micron size—and their arrays. The current renewal of interest pertains to similar problems, but for nanoparticles and nanoarchitectures based on them. Electronic structure calculations have made it clear that, in terms of their electromagnetic properties, large nanoparticles can be well described within the framework of the electrodynamics of continuous media (J. M. Montgomery, T.-W. Lee, and S. K. Gray, J. Phys. Cond. Matter 20, #323201 (2008), incorporated herein by reference).

Arrays of nanoparticles for study are either adsorbed on inert substrates or are let to self assemble at the liquid-gas or liquid-liquid interface. The formation of silver nanoparticle layers on liquid interfaces was reported in the pioneering papers of Yogev and Efrima (D. Yogev and S. Efrima, J. Phys. Chem. 92, 5754 (1988), and S. Efrima, Crit. Rev. Surf. Chem. 1, 167 (1988), both incorporated herein by reference). Prior methods comprised forming several micron thick colloid films of enriched silver content at the water/organic liquid interface, called MELLFs (metal liquid-like films). An alternative method of preparation of similar films made it possible to create much thinner films, also located at a bare water surface. This method was widely exploited in order to prepare materials which could be used for the fabrication of a novel class of liquid mirrors. In particular, it was shown that a quasi two-dimensional array of nanoparticles—on average of 50 nm in diameter, provides practically an ideal mirror surface; spectral characteristics of reflection were studied in this work, but reflection was substantial in all visible spectrum. Various aspects of the electrodynamic response of such nanoparticle layers to incident electromagnetic radiation have been studied, along with their dependence on the concentration of nanoparticles, their size and shape.

It is known that the surface concentration of nanoparticles has an effect on the reflection of light. However, classical electrodynamics teaches that a metal film much thinner than the skin depth can transmit nearly all the light. The minor portion of it that can be reflected shows strong frequency dispersion. Thus such a thin layer (e.g., nearly 50 nm) cannot be used as a mirror. But if the film is inhomogeneous, composed of isolated metal nanoparticles, the situation may be different. Nanoparticles may work as antennas for light. Localized plasmon modes excited by the incident electromagnetic radiation fluctuate like giant dipoles that in turn emit light. Whereas a single nanoparticle emits light in all directions, in an array of nanoparticles that is coherently excited by incoming light waves emitted light is generated that is coherent from nanoparticle to nanoparticle, enhancing the emission along the specular direction rather than to the other side of the array. The dominance of this “reflected” light is incomplete, as it never achieves 100 percent reflection; the competition between the reflected and transmitted light depends strongly on the light's wavelength. Indeed, the plasmon-mediated reflection coefficient has a sharp frequency dependence, with a narrower resonance for smaller nanoparticles that is shifted to the blue. Absorption of light takes place via dissipation of surface plasmons. In materials with low dissipation/‘long living’ plasmons such as silver and gold, the portion of absorbed light is insignificant.

If the metal nanoparticles are dispersed in the bulk of the liquid, rather than concentrated at the surface, then the specular reflectivity is likely to be poor, even if the polarizability of an individual nanoparticle is large. For a dilute solution of nanoparticles the scattered waves from the nanoparticles cannot be expected to be in phase with each other, as required to generate specular reflection, due to the different distances of the nanoparticles from the surface. Such a solution is likely to generate substantial Rayleigh scattering, and leads to the characteristic coloration of very dilute solutions of nanoparticles. If the sharply-peaked surface plasmon resonance lies outside the visible band of frequencies then such a dilute bulk solution may also be highly transmissive.

Two effects are important for voltage-tunable highly reflective behavior from a dense monolayer of nanoparticles: phase coherence in the scattered waves from nanoparticles at the surface, and the further enhancement of the nanoparticle polarization in response to the dipole fields of nearby nanoparticles. This second phenomenon, described by a generalized Maxwell-Garnet theory (C. Maxwell-Garnett, Philos. Trans. Roy. Soc. London, Ser. A. 203, 385 (1904), incorporated herein by reference), also broadens the optical resonance due to the surface plasmons and shifts the frequency of the resonance to the red and to the blue for the plasmon modes that are parallel and perpendicular to the interface, respectively. A dense monolayer of large nanoparticles thus may possess a reflection band covering most of the visible range, depending on the size, shape and surface density of nanoparticles.

### SUMMARY

The following presents a simplified summary of the subject disclosure in order to provide a basic understanding of some aspects thereof. The subject summary is not an extensive overview of the subject disclosure. It is intended to neither identify key or critical elements of the subject disclosure nor delineate any scope. The sole purpose of the subject summary is to present some concepts of the subject disclosure in a simplified form as a prelude to the more detailed description that is presented hereinafter.

One or more embodiments of the subject disclosure provide systems and methods for control of a nanoparticle surface coverage via means of a potential variance across an interface of two immiscible electrolytic solutions (ITIES). Typical ITIES is composed of water and oil (e.g., 1,2-dichloroethane, or nitrobenzene) that do not mix, but instead form an interface with each other. The aqueous phase (e.g., aqueous phase 110) can contain an inorganic electrolyte, such as, for example, L⁺Cl⁻ which prefers to dissolve in water; for such electrolyte, free energy of transfer of each such ion from water to oil is about +0.5 eV. More generally, in an aspect, the inorganic electrolyte in the aqueous phase (e.g., aqueous phase 110) can be embodied by a salt having a free energy of transfer of each ion in the salt from the aqueous phase to the oily phase of at least about 0.1 eV (e.g., 0.5 eV). In certain embodiments, the oily phase contains large organic ions, such as tetralkylammonium⁺ and tetraphenylborate⁻, and the cost of transferring each of the ions to the aqueous phase is of the same order of magnitude.

When ITIES is put between two electrodes in the electrochemical cell, it remains ‘immiscible’ until the potential bias balances the free energies of transfer, and the ion traffic across the interface becomes possible. It is experimentally known that for typical ITIES with ions characterized by the largest free energies of transfer the breakdown voltage is about 0.8 V. Below it, ITIES remains ideally polarizable, e.g., under the bias voltage two back-to-back electrical double layers can form on the two sides of the interface without the ion current across the interface. The thickness of each double layer depends on electrolyte concentrations; for example, for concentration of nearly 0.1 M, such thickness is about 1 nm. As a result, a strong electric field (e.g., approximately 10⁷ V/cm) can be localized in the narrow vicinity of the interface, and this can be used for various purposes, including the control of a nanoparticle surface population, or coverage, by voltage variation within about 200 mV interval—for such voltage variation, the nanoparticle surface coverage ranges from nearly a full monolayer coverage (e.g., mirror) to zero or substantially zero coverage (e.g., transparent).

In the subject disclosure, nanoparticle coverage of the interface between two immiscible media can dictate at least one optical property of the interface in response to application of an electric potential difference across the interface: Nanoparticle coverage can render the interface transparent or substantially transparent, or a mirror, or can provide Faraday rotation of the optical polarization of light incident normal to the interface and propagating through the interface.

Additional aspects, features, or advantages are set forth in part in the more detailed description which follows and the annexed drawings, or may be learned by practice. Such aspects, features, or advantages can be realized and attained by means of the elements and combinations particularly pointed out in the subject specification and the annexed drawings. These aspects, features, or advantages are indicative, however, of but a few of the various ways in which the principles of the subject disclosure can be employed; the subject disclosure is intended to include all such aspects or features and their equivalents. It is to be understood that both the foregoing general description and the following detailed description are illustrative and explanatory only and are not restrictive. Other objects, advantages, aspects, and novel features of the subject disclosure can become apparent from the following detailed description of the innovation when considered in conjunction with the annexed drawings.

### BRIEF DESCRIPTION OF THE DRAWINGS

The accompanying drawings, which are incorporated in and constitute a part of the subject specification, illustrate embodiments and together with the description, serve to explain the principles of the methods and systems:

FIG. 1A illustrates an example embodiment of an ITIES in accordance with aspects described herein;

FIG. 1B is an example illustration of the light reflection and refraction (dotted arrows) from the monolayer of nanoparticles adsorbed at an ITIES, with an incident beam coming from the oil side;

FIG. 1C illustrates a similar example system as shown in FIG. 1B, but with nanoparticles removed from the interface, light propagates through the system with a minor absorption in the phase, as both phases are transparent to light in the visible spectrum;

FIG. 2 illustrates an example energy profile of a nanoparticle near an ITIES in accordance with aspects described herein;

FIG. 3 provides an example illustration of the interface, or surface, coverage Γ by nanoparticles as a function of the energy splitting (−u) between the minimum of adsorption well and the maximum of the barrier given in units of the thermal energy in accordance with aspects described herein;

FIGS. 4A-4B illustrate frequency dependence of the coefficient of reflection of electromagnetic waves from the aqueous/1,2 dichloroethane solution interface covered by silver nanoparticles in accordance with aspects described herein. The electromagnetic waves are incident from the organic electrolyte phase;

FIGS. 5A-5B depict an example system for control of optical properties of an interface between two immiscible media comprising nanoparticles in accordance with aspects described herein;

FIG. 6 illustrates total Faraday rotation as a function of EM radiation wavelength for magnetic nanoparticles in two example scenarios in accordance with aspects described herein—first scenario comprising magnetic nanoparticles dispersed in bulk of at least one of a first medium or a second medium, and second scenario comprising magnetic nanoparticles localized at the interface between the first medium and the second medium;

FIG. 7 illustrates dimensionless Faraday rotation power θ_{Bulk}/θ₀ of magnetic nanoparticles dispersed in bulk of at least of a first medium (e.g., a first electrolytic solution) or a second medium (e.g., a second electrolytic solution) as a function, of coverage of magnetic nanoparticles at the interface between the first medium and the second medium in accordance with aspects of the subject disclosure;

FIG. 8 depicts dimensionless Faraday rotation power for magnetic nanoparticles dispersed in bulk, and relative dimensionless Faraday rotation power of magnetic nanoparticles localized at an interface and that of nanoparticles dispersed in bulk of at least one of the first medium or the second medium that form the interface in accordance with aspects described herein;

FIG. 9 illustrates a plot of coverage of magnetic nanoparticles at an interface between a first medium (e.g., a first electrolytic solution) and a second medium (e.g., a second electrolytic solution) as a function of size (e.g., radius) of the magnetic nanoparticles in accordance with aspects of the subject disclosure, wherein the illustrated coverage provides maximal Faraday rotation power; and

FIG. 10 illustrates an example method for controlling optical properties of an interface between at least two immiscible media according to aspects of the subject disclosure.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular, yet not exclusive, embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it can be understood that the particular value forms another embodiment. It can be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers, steps, or acts. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

Voltage control of the nanoparticle concentration at the interface was possible because the nanoparticles themselves are ‘functionalized’: covered by ligands with functional, usually acidic terminal groups that dissociate in water. Depending on pH, either most of the ligands can dissociate in basic solutions or a small portion in more acidic solutions. Dissociation of every neighboring terminal group is impeded by the Coulomb repulsion between them. But in electrolytic solution this repulsion can be effectively screened, and thus roughly every second group can dissociate or not, subject to the pH of the solution that provides control of the net negative charge of nanoparticles. But the greater the charge, the stronger the effect of the electric field at the ITIES on the localization of nanoparticles. Generally polarizing the aqueous side negatively relative to the oil side can push negatively charged nanoparticles to the interface; positive polarization can tend to remove them from the surface.

Experimental results have shown that localization of nanoparticles at ITIES is possible (Y. Cheng and D. J. Schiffrin, J. Chem. Soc., Faraday trans., 92, 3865 (1996); C. Johans, R. Lahtinen, K. Kontturi and D. J. Schiffrin, J. Electroanal. Chem. 488, 99 (2000); both incorporated herein by reference). Moreover, fully reversible adsorption-desorption with varying the bias voltage has been achieved (B. Su, J. P. Abid, D. J. Fermin, H. H. Girault, H. Hoffmannova, P. Krtil, Z. Samec, J. Am. Chem. Soc. 2004, 126, 915; B. Su, D. J. Fermin, J.-P. Abid, N. Eugster, H. H. Girault, J Electroanal. Chem, 2005, 583, 241; both incorporated herein by reference) in agreement with later theoretical calculations (M. Flatté, A. A. Kornyshev, M. Urbakh, J. Phys. Cond. Matter 20 #0713102 (2008), incorporated herein by reference) for small particles of about 2 nm in size and for the case of a small charge on the nanoparticles. The voltage dependent adsorption isotherm, which relates the surface coverage with the overall volume concentration of nanoparticles, has been measured and the estimated and measured bias voltages needed to bring nanoparticles to the surface or remove them to the bulk were found to be smaller than the ITIES window of ideal polarizability.

In another aspect, for optical applications larger nanoparticles of about 20 nm to about 500 nm size can be utilized. The synthesis of such particles, localization at the ITIES, and subsequent plasmon resonance spectroscopy has been reported (see L. Ribeaucourt, Assembly of gold nanoparticles and introduction to surface plasmon resonance, Masters Dissertation (Supervisors: H. Girault and D. Lincot), Ecole Polytechnique Federale de Lausanne, Lausanne (2008), incorporated herein by reference). However, the charge on the particles synthesized by the Turkevich method (as known to one of ordinary skill in the art and as described in J. Turkevich, P. C. Stevenson, and J. Hiller, Discuss. Faraday Soc. 11, 55 (1951) in which the synthesis takes place in water and ligands contain mercaptane groups, and which is incorporated herein by reference), formed due to the adsorption of citrate and gold-cloride anions, was only about −50 e for 16 nm diameter particles. To manipulate large nanoparticles with an electric field much larger charges are desired. The adsorption of the synthesized nanoparticles to the interface in preliminary studies was irreversible, with a strong tendency to spontaneously form rather thick (crystal-like) films.

However, independently, a set of more decisive results has been published (see J.-P. Abid, M. Abid, H. H. Girault, and P.-F. Brevet, J. Phys. Chem. C 111, 8849-8855 (2007), incorporated herein by reference). These were obtained for relatively large silver-coated gold nanoparticles (Au core-Ag shell) of 16-19.8 nm radius in polarized water/1,2-dichloroethane ITIES system. The effect of silver fraction, varied from 0 to 0.4, was systematically studied. Since in those measurements the electrolytes contained chloride ions, the charge on the nanoparticles was formed not only due to functionalization by citrates but also due to chemisorption of Cl⁻ anions, which is particularly strong on silver. By electrophoresis measurements it was shown that the average charge on nanoparticles ranges between −62|e| for pure gold to −235|e| for Au_{0.6}Ag_{0.4}, where |e| is the magnitude of the charge of a single electron. Whereas adsorption at the ITIES of purely gold nanoparticles was found irreversible, highly charged core-shell particles has shown reversibility of adsorption-desorption. Negative polarization of water with respect to oil promoted adsorption, whereas positive polarization promoted desorption. This was detected through emergence at negative polarizations of a specific second-harmonic generation (SHG) signal, absent without nanoparticles. This signal disappeared with positive polarizations. In particular, FIG. 7 of Abid (incorporated herein by reference, as indicated hereinbefore) demonstrates how this SHG signal turns on and off with potential variation, with a clear difference of the effect for Au_{0.6}Ag_{0.4} and Au_{0.9}Ag_{0.1} particles.

Provided in the subject disclosure are systems, methods, and apparatuses for control of nanoparticle coverage at an interface amongst two immiscible media. In an aspect, the description of the field induced adsorption to ITIES first developed for small nanoparticles with a minute charge on them is adapted to the case of large nanoparticles with a dense population of ligands and almost every second ligand's terminal group dissociated, resulting in substantial charge on nanoparticles.

A further consideration for suitable electrical tuning of the optical properties can be the response time of the nanoparticles to the applied electric field. The initial response of the nanoparticles to the applied field can be to migrate to the surface. The presence of ions in the water, however, can lead to the formation of a double layer at the interface and an efficient screening of the electric field in the bulk of the liquid. Once the electric field is so screened only diffusion can take the nanoparticles to the surface and their accumulation can be very slow. Nanoparticles can be expected to diffuse more slowly than ions to the interface because the nanoparticles generally have larger sizes than the ions. In the initial transient period before the electric field is screened, however, the nanoparticles can respond rapidly, as their charge per particle can be significantly much larger than the charge per ion. Thus criteria is considered herein for optimizing the migration time of the nanoparticles to or from the interface when the electric field applied to the system is changed. At least two regimes are described for nanoparticle transport to and from the surface. During the initial transient period the nanoparticles can drift toward the surface under the influence of the incompletely screened electric field. Although one might expect the drift of the nanoparticles to be slow, due to their large size and small diffusion constant, the nearly 1000 net charges on its surface can cause the nanoparticle drift to contribute significantly to the surface density. For approximately 20 nm nanoparticles a monolayer can be accumulated easily within about 0.1 second during the drift regime. The second regime of nanoparticle transport, occurring after the applied electric field is screened, can be random diffusion. In this regime the transport of the nanoparticle can not be enhanced by the large surface charge, and the accumulation rate of nanoparticles at the surface can be slower. Accordingly, in an aspect, the nanoparticle concentration in bulk can be selected such that a monolayer or nearly a monolayer of nanoparticles is accumulated at the interface in the drift regime.

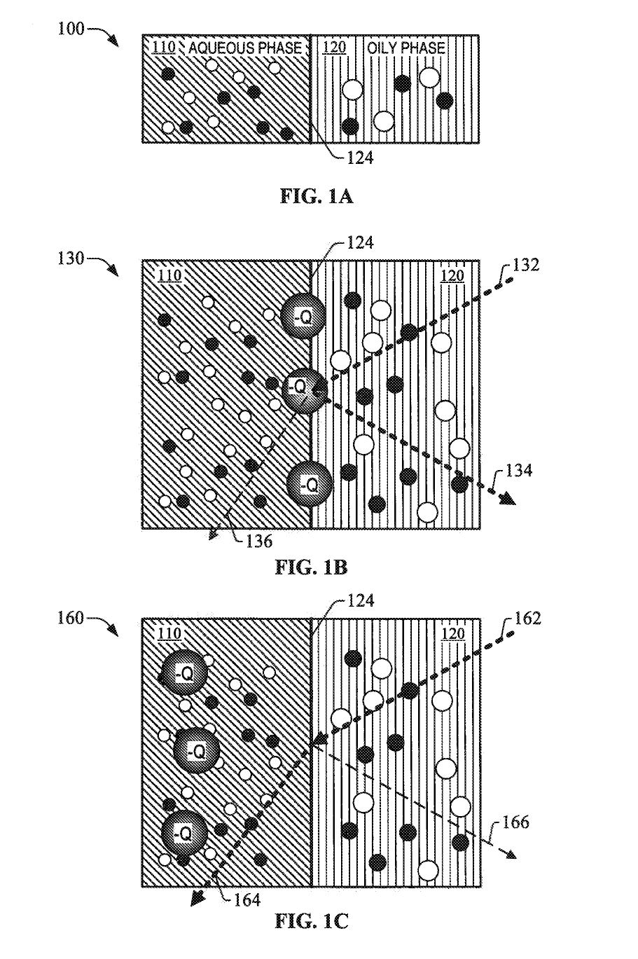

Thus, as described herein, an ITIES provides a means for fast control of the nanoparticle surface population, or coverage, by voltage variation within about 200 mV interval—from a full or substantially full monolayer coverage to zero or substantially zero coverage with corresponding dramatic change of optical (e.g., reflective, transmissive, and the like) properties of the interface in the ITIES. FIG. 1A illustrates an example embodiment 100 of an ITIES in accordance with aspects of the subject disclosure. Example embodiment 100 includes an aqueous phase 110 (e.g., water) representative of a first material medium (also referred to as first medium), and an oily phase 120 (e.g., oil) representative of a second material medium (also referred to as second medium). The aqueous phase 110 and the oily phase 120 form an interface 124, the ITIES. Aqueous phase 110 can be an inorganic electrolyte with a first group of cations (represented with black circles) and anions (represented with open circles), and oily phase 120 can be an organic electrolyte with a second group of the cations (represented with black circles) and anions (represented with open circles). To distinguish anions and cations in the first group from the second group, circles of different sizes are employed in the FIG. 1A.

FIG. 1B is a diagram 130 that illustrates light reflection (represented with thick dashed arrow 134) and refraction (represented with thin dashed arrow 136) from a monolayer of nanoparticles adsorbed at the ITIES (e.g., interface 124), with an incident beam of light (represented with thick dashed arrow 132) impinging from the oily phase 120. In diagram 130, the monolayer of nanoparticles is pictorially represented with three grey circles, each with a label “−Q” representing the charge, in units of a single electron charge, of a nanoparticle associated with such label. In non-idealized, realistic systems, nanoparticles are orders of magnitude larger than the cations (represented with black circles) and anions (represented with open circles) of both inorganic and organic electrolytes. FIG. 1C illustrates a diagram 160 that represents an example system similar to that shown in diagram 130 of FIG. 1B, but with nanoparticles (circles with a “−Q” label) removed from the interface 124. As illustrated, light (e.g., incoming beam 132) propagates through the interface 124 with a minor absorption in the aqueous phase 110, as both phases are transparent or substantially transparent to light in the visible portion of the spectrum of electromagnetic radiation. In certain embodiments, the refraction index of the aqueous phase 110 is only slightly affected by the minute concentration of nanoparticles in it, which contribute but negligibly to the absorption of light in the aqueous phase. Reflection and refraction at the interface is standard for the given difference between the refraction indices of oil and aqueous phase (if they are balanced by additives or by adjusting concentrations of electrolytes, the light can go straight through the interface). Reversible electric control of nanoparticle concentration may also be possible at a solid/liquid interface, such as between indium tin oxide (ITO) and water or an aqueous phase.

### Formation of Nanoparticles

There are a number of ways that metal (e.g., gold, silver and gold-core/silver-shell) nanoparticles suitable for optical application at ITIES can by synthesized. (See Turkevich (previously incorporated herein by reference) and M. Brust, M. Walker, D. Bethell, D. J. Schiffrin, R. Whyman, Chem. Commun. 1994, 801-802, incorporated herein by reference.) In one aspect, silver nanoparticles can be utilized for optical voltage-tunable nanoplasmonics, as the single-particle plasma resonance of the nanoparticles in aqueous solution lies in the violet-ultraviolet rather than in the visible. In another aspect, gold nanoparticles can be employed. Gold nanoparticles can be produced in a liquid by reduction of chloroauric acid (H[AuCl₄]), although more sophisticated methods exist. Upon dissolving H[AuCl₄] a reducing agent is added, which causes Au³⁺ ions to be reduced to neutral gold atoms. After a substantial concentration of gold atoms is formed in the solution, the gold atoms gradually agglomerate forming sub-nanometer cores for further adhesion of gold atoms to such cores. With vigorous stirring, a relatively monodisperse solution of nanoparticles can be reached. But to prevent further growth and sedimentation of nanoparticles, a stabilizing agent which chemisorbs or chemically binds to the surfaces of the nanoparticles can be added. It may contain organic or inorganic ligands. If the particles are synthesized in water and agglomeration of the nanoparticles is intended to be prevented by charging them with charges of the same sign, exemplary ligands can be those containing acidic terminal groups. In an aspect, ligands containing acidic terminal groups can dissociate in water, and the degree of dissociation—and thereby the net charge on the nanoparticles—can be controlled by the pH. As described herein, the charge of nanoparticles can be further increased by irreversible chemisorption of anions. For silver nanoparticles, candidates for anions comprise chloride-ion or sulphate-ions.

In one aspect, localization of nanoparticles at ITIES is for small particles of about 2 nm size and for the case of acidic pH, corresponding to a small charge on the nanoparticles. In another aspect, for optical applications larger nanoparticles with characteristic sizes from about 20 nm to about 500 nm can be utilized. A characteristic size of a nanoparticle is a length indicative of the size of the nanoparticle—for a spherical nanoparticle, for example, the radius of such nanoparticle can represent its characteristic size; however, for an asymmetric nanoparticle, other length associated with such nanoparticle can be utilized as its characteristic size. Thus, as set forth herein in various aspects, description of electric field induced adsorption to an ITIES or other interface between two immiscible media generally relates to nanoparticles with characteristic sizes ranging from about 20 nm to about 500 nm, and the resonance light reflection from the ITIES system with such nanoparticles. The various aspects of the subject disclosure also relate, or are applicable, to smaller nanoparticles with characteristic sizes from nearly 1 nm to nearly 20 nm.

### Field Controlled Adsorption of Nanoparticles

The Balance of Forces

Adsorption of nanoparticles onto the ITIES can be described by an adsorption isotherm. The latter can be generally determined by the balance of forces and the entropy: the driving force which attracts a nanoparticle to the interface, interactions between nanoparticles at the interface, and the tendency to increase the entropy by ‘disappearing’ in the bulk. If the absolute value of the depth of the potential well for the nanoparticles is much greater than the thermal energy, there can be not much of an “adsorption isotherm” in the conventional sense. If understood as a relationship between the concentration of nanoparticles in the bulk and the surface coverage, the adsorption isotherm can show weak dependence of surface coverage on the average concentration in the bulk. However, another relevant kind of isotherm can be the dependence of the coverage on the parameters which control the depth of the well: For example, the dependence of the coverage of nanoparticles at the interface on electric potential drop (or difference) across the interface.

The balance of forces that can determine localization of a single nanoparticle at the ITIES or, more generally, at an interface amongst two immiscible media is described as follows.

Determination of the Adsorption Isotherm

In order to describe the adsorption isotherm into the bottom of single particle potential well, the chemical potential of a nanoparticle in the bulk of the solvent is equalized to its chemical potential in the well, using mean-field approximation of Langmuir-Frumkin type (see, e.g., B. B. Damaskin, O. A. Petrii, and V. V. Batrakov, Adsorption of organic compounds on electrodes, Plenum, New York, 1971, 499, incorporated herein by reference).

Namely, for the chemical potential of a particle in the interfacial layer:

$${μ}_{s} = {k}_{B} T \{ u + 2 b Γ + ln \frac{Γ}{1 - Γ} \} \qquad ( 1.1 )$$

Here, k_{B} is the Boltzmann constant, T—absolute temperature; u the energy in the minimum of a single-particle potential well (the quantity which depends on bias voltage) calculated relative to the energy of the particle in the bulk of water (u<0 corresponds to the net attractions to the interface) and given in the units of the thermal energy k_{B}T; b is the interaction constant, and Γ is the coverage (e.g., the portion of the monolayer that nanoparticles can form at the interface). Thus, by definition, Γ=Nₛ/ N̅ₛ where Nₛ is an actual number of particles in the adsorbed layer and N̅ₛ is its maximal amount.

In this form of the chemical potential, possibility of a multi-layer adsorption is not taken into account. The second term in the brackets is Frumkin's interaction term which takes into account interaction of a given particle with all other adsorbed particles; the third term is a Langmuir term which resists the formation of a dense monolayer.

In a similar way, the chemical potential in the bulk can written as

$$\begin{matrix}{μ}_{v} = {k}_{B} T ln \frac{{N}_{v}}{{\overline{N}}_{v} - {N}_{v}} ≡ {k}_{B} T ln \frac{β - Γ}{γ - β + Γ} & ( 1.2 ) \\ Here γ = \frac{{\overline{N}}_{v}}{{\overline{N}}_{s}} , β = \frac{N}{{\overline{N}}_{s}} , & ( 1.3 )\end{matrix}$$

where N̅ᵥ is the maximal number of nanoparticles that can be packed in the volume of water; N is the total number of nanoparticles in the system (composed of the number of nanoparticles adsorbed at the surface and of those that remain in the bulk). Expression (1.2) is purely entropic: it does not contain any energy terms. Indeed, the energy of a single particle in the water bulk (or aqueous phase) is taken for zero, and the concentration of nanoparticles in the bulk is so small that they do not interact with each other. Having put μₛ=μᵥ, the following is obtained:

$$\frac{Γ}{1 - Γ} \cdot \frac{γ - β + Γ}{β - Γ} = exp \{ - ( u + 2 b Γ ) \} \qquad ( 1.4 )$$

Apart from the second factor in the right hand side, Eq. (1.4) has a form of a Frumkin isotherm. But in the context of the problem considered herein, γ>>β. Furthermore to make the response speed of device fast enough, β>>1, so that Eq. (1.4) can be rewritten as

$$\frac{Γ}{1 - Γ} \cdot \frac{γ}{β} \approx exp \{ - ( u + 2 b Γ ) \} .$$

### Introducing

$$f ≡ \frac{γ}{β} = \frac{{\overline{N}}_{v}}{N} \qquad ( 1.5 )$$

the following is shown:

$$- u \approx 2 b Γ + ln \frac{Γ}{1 - Γ} + ln f \qquad ( 1.6 )$$

Generally, f may adopt large values. However, in the case of adsorption without a barrier, −u—the depth of the well given in units of thermal energy k_{B}T—can be in general much greater than ln f. In such a scenario the entropic effects accumulated in f are not important and the last term on the right hand side of Eq. (1.6) can be omitted. Such omission means that the coverage (a) can be determined by adsorption energy and the repulsion of nanoparticles, and (b) does not depend on the concentration of nanoparticles in the bulk.

On that basis, it can be shown that the calculation of the interaction constant b, also depends on Γ. This makes the adsorption isotherm more complicated.

First, the energy U of one nanoparticle interacting with other nanoparticles in a sub-monolayer film is calculated. The simplest approximation for such calculation can be the ‘cut-out disc’ approximation, within which the particles are considered to be homogeneously distributed on a surface. Such approximation yields,

$$U = {n}_{s} 2 π {\int }_{{r}_{s}}^{∞} d RRW ( R ) , \qquad ( 1.7 )$$

where nₛ is the number of adsorbed nanoparticles per unit surface area (‘surface particle density’), W(R) is a pair interaction potential, R is the absolute value of the radius-vector lying in the interfacial plane centered at the center of a selected nanoparticle; rₛ is the mean radius per particle in the adsorption layer:

$${n}_{s} = \frac{1}{π {r}_{s}^{2}} .$$

In terms of surface coverage and a radius of nanoparticles (all of them are assumed to have the same radius), nₛ=Γ/(4πa²) and

$${r}_{s} = \frac{2 a}{\sqrt{Γ}} ,$$

so that

$$U ( Γ ) = \frac{Γ}{2 {a}^{2}} {\int }_{\frac{2 a}{\sqrt{Γ}}}^{∞} d RRW ( R ) \qquad ( 1.8 )$$

Once U(Γ) is calculated, the contribution of the pair interaction between the particles in the layer to the total energy of the layer can be calculated,

$${G}_{int} ( Γ ) = \frac{1}{2} {N}_{s} U ( Γ ) = \frac{{\overline{N}}_{s}}{2} Γ U ( Γ ) \qquad ( 1.9 )$$

Hence the corresponding contribution to the chemical potential

$${μ}_{int} = \frac{\partial {G}_{int} ( Γ )}{\partial {N}_{s}} = \frac{1}{{\overline{N}}_{s}} \frac{\partial {G}_{int} ( Γ )}{\partial Γ} = \frac{1}{2} \frac{\partial }{\partial Γ} [ U ( Γ ) Γ ] \qquad ( 1.10 )$$

In order to calculate U(Γ), an expression is needed for W(R). Such expression generally can be substantially complicated. In an aspect, electrostatic interactions screened by electrolytic solutions can be taken into account primarily; examples of substantial simplifications associated with inclusion of such electrostatic interactions can comprise, for example, disregarding one or more phenomena associated with the influence of the interface on the pair interaction, and any effect(s) of nonlinear screening. Accordingly, W(R) can be represented by:

$$W ( R ) = {k}_{B} T \cdot \frac{{Z}^{2} {L}_{B}}{2 {a}^{3} {κ}^{2}} \cdot {e}^{2 a κ} \cdot {e}^{- κ R} \qquad ( 1.11 )$$

Substitution of Eq. (1.9) into (1.8) gives

$$U ( Γ ) = {k}_{B} T \cdot \frac{{Z}^{2}}{4} \cdot \frac{{L}_{B}}{{a}^{5} {κ}^{4}} \cdot Γ \cdot {e}^{- 2 a κ ( \frac{1}{\sqrt{Γ}} - 1 )} \cdot ( \frac{2 a κ}{\sqrt{Γ}} + 1 ) \qquad ( 1.12 )$$

Further substituting Eq. (1.12) into (1.10) provides:

$${μ}_{int} = {k}_{B} T \cdot \frac{{Z}^{2}}{4} \cdot \frac{{L}_{B}}{{a}^{5} {κ}^{4}} \cdot Γ \cdot {e}^{- 2 a κ ( \frac{1}{\sqrt{Γ}} - 1 )} \cdot {( \frac{a κ}{\sqrt{Γ}} + 1 )}^{2} \qquad ( 1.13 )$$

Hence, the interaction constant in the adsorption isotherm,

$$b = \frac{{μ}_{int}}{2 Γ {k}_{B} T} , \qquad ( 1.14 )$$

reads

$$b = \frac{{Z}^{2}}{8} \cdot \frac{{L}_{B}}{{a}^{5} {κ}^{4}} \cdot {e}^{- 2 a κ ( \frac{1}{\sqrt{Γ}} - 1 )} \cdot {( \frac{a κ}{\sqrt{Γ}} + 1 )}^{2} \qquad ( 1.15 )$$

The substitution of Eq. (1.15) into Eq. (1.6) provides the complete adsorption isotherm

$$- u \approx ln \frac{Γ}{1 - Γ} + \frac{{Z}^{2}}{4} \cdot \frac{{L}_{B}}{{a}^{5} {κ}^{4}} \cdot Γ \cdot {e}^{- 2 a κ ( \frac{1}{\sqrt{θ}} - 1 )} \cdot {( \frac{a κ}{\sqrt{θ}} + 1 )}^{2} \qquad ( 1.16 )$$

In order to avoid particle agglomeration, the nanoparticles can be protected by ligands with acidic terminal groups, attached to the particles via thiol groups. Equilibrium values of the number of charges per particle can be affected by acid ionization constant and depend on pH. If, as described, every second group is dissociated (in basic solutions, for example), for a 20 nm nanoparticle, qₙₚ=−1000|e| net negative charge can be obtained, where |e| is the magnitude of the charge of a single electron. Solvation of such highly charged nanoparticles drives such nanoparticles towards the aqueous phase (e.g., aqueous phase 110), whereas an applied electric field may be used to drive such nanoparticles towards the organic phase. This results in an electrochemical potential minimum at the interface, deepened dramatically by surface tension. The latter takes place when the absolute value of the difference of surface energies of the interface of a functionalized nanoparticle with water (or, more generally, with an aqueous phase) and with oil (or, more generally, with an oily phase) is smaller than the energy of the fragment of the oil-water interface (or, more generally, the aqueous-phase-oily-phase interface) blocked by the nanoparticle, when the functionalized nanoparticle is adsorbed at the interface.

Another effect that can influence the energy profile of nanoparticles and the depth of the well is line tension. When positive, the line tension pushes the nanoparticle on either side of the interface, which results in a further shift of the well to water (or, more generally, an aqueous phase) side of the ITIES, and a possibility of a barrier preceding the well. It should be appreciated that solvation also contributes to the barrier, but primarily (and, in certain embodiments, exclusively) on the water side (or, more generally, the aqueous phase).

Nanoparticle polarizability also can draw nanoparticles toward the maximal gradient of electric field, which is on the two sides of the interface (e.g., ITIES or, more generally, an interface amongst two immiscible media), but close to it. Such effect can be generally small compared with monopole charge effects.

The free energy gain due to surface tension scales with the characteristic radius of the nanoparticle, as R². The charge of the nanoparticles also can scale as R², as the number of ligands increases roughly proportionally to surface area of a nanoparticle. Thus the energy-in-electric-field term is also ∝R². The hydration energy gain to be in water scales ∝R³ (the hydration energy is proportional to the square of the charge ∝Z²∝R⁴ but the energy for a given charge is roughly ∝R⁻¹), whereas line tension scales ∝R.

The resulting well depth, or the absence thereof, generally can be determined by the competition between all such factors. But an important factor to control the resulting well depth externally is the value of an electric field applied across the interface between water (or, more generally, an aqueous phase) and oil (or, more generally, an oily phase). In the absence of an applied electric field, smaller nanoparticles (e.g., nanoparticles with characteristic size of about 1.5 nm) tend to remain in water (or, more generally, in the aqueous phase). Thus, to localize smaller nanoparticles at the interface between water and oil (or, more generally, at the interface between at least two immiscible media), an electric field pushing such smaller nanoparticles to the surface associated with the interface can be applied. In an aspect, the electric fields available for ITIES can provide deep potential wells for a stable arrangement of nanoparticles at the interface, and variation of such electric fields can reversibly control the well depth and therefore the interface coverage by nanoparticles. Yet, in certain embodiments, smaller nanoparticles may not be best suited for nanoplasmonic applications.

With larger nanoparticles (e.g., particles with characteristic size from about 20 to about 500 nm), an opposite effect can occur if the larger nanoparticles are weakly charged. The surface tension gain can be substantial; in the absence of an external electric field, the surface tension gain can push a large nanoparticle towards the interface, where the large nanoparticle can be trapped in a deep well. But with an electric field strong enough and oriented to push the large nanoparticle back to the water (or, more generally, an aqueous phase), the well can be eliminated or made metastable. However, depending on one or more parameters and if large nanoparticles are strongly charged, it can be possible that the hydration preference for being in water (or, more generally, an aqueous phase) may be such that a substantial electric field is applied thereby pushing the large nanoparticles towards oil (or, more generally, an oily phase) to localize such large nanoparticles at the interface.

In an aspect, in order to manipulate small nanoparticles it can be generally beneficial to consider large concentrations (e.g., about 0.1 M, with M being one of the conventional units of concentration) of electrolytes in both solvents. But for larger nanoparticles this may not be a good strategy. Indeed, the electric field can be localized in a region of 1 nm near the interface, which can be much smaller than the size of the nanoparticles. If so, most of the charges on larger nanoparticles can lie outside the double layer region; there can be thus a negligible effect of the bias voltage on localization of small nanoparticles. In another aspect, in order to enhance the voltage control of the position of large nanoparticles, the electrolyte concentration can be diluted, at least in water.

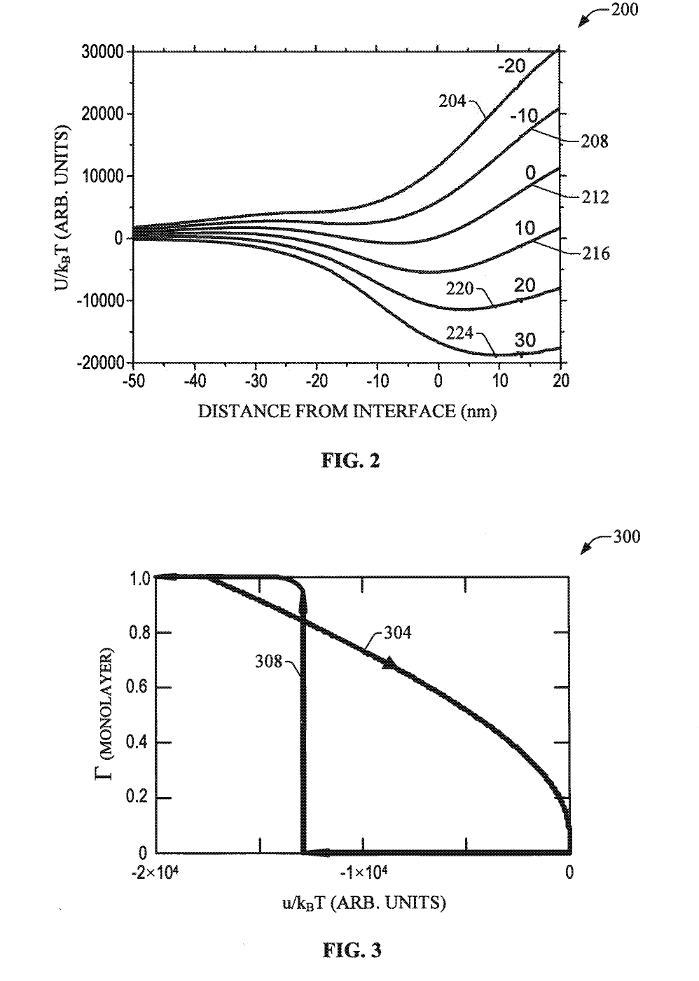

FIG. 2 displays the calculated potential energy profile U of a large nanoparticle near the ITIES, the large nanoparticle having a radius of about 20 nm. The resulting features of the curves depend on a fine interplay between the system parameters. The shown curves representative of such potential energy profile correspond to certain values of those parameters and they are focused on highlighting the possibility for voltage, or electric potential, induced adsorption-desorption of large nanoparticles, an effect attained by embodiments of optical devices described herein.

FIG. 2 illustrates a diagram 200 that presents various example energy profiles of a nanoparticle near the ITIES. In chart 200, z>0 represents locations within the organic phase, and z<0 represents locations within the aqueous phase. Curves 204 through 224 in diagram 200 correspond to indicated electric potential drops (or differences) between the bulk of the organic phase and the bulk of the aqueous phase; the electric potential drop is provided in units of k_{B}T (which is≈25 mV at room temperature). The electric potential drops are indicated by numbers next to each of the curves shown in diagram 200: In particular, curve 204 corresponds to V/k_{B}T=−20; curve 208 corresponds to V/k_{B}T=−10; curve 212 corresponds to V/k_{B}T=0; curve 216 corresponds to V/k_{B}T=10; curve 220 corresponds to V/k_{B}T=20; and curve 224 corresponds to V/k_{B}T=30. In FIG. 2, the various example energy profiles are calculated for a nanoparticle radius of approximately 20 nm, as indicate previously; total number of charges on ligands coupled to a nanoparticle: qₙₚ=−1000|e|, with |e| the magnitude of the charge of a single electron, as indicated hereinbefore; and an inverse Debye length in water, κ=0.05 nm⁻¹.

Field Induced Adsorption-Desorption

From the various curves in diagram 200 in FIG. 2, it can be appreciated that several features can influence the adsorption-desorption patterns: (I) At a sufficiently large positive electric potential drop between oil (e.g., oily phase 120) and water (e.g., aqueous phase 110), there is an approximately 10⁴ k_{B}T deep well, not separated from the bulk by a potential barrier. Such a well binds nanoparticles as long as they diffuse to the edge of the well. At sufficiently large negative potential drop between oil and water, there is a steady repulsion of nanoparticles from the interface towards the bulk of the aqueous phase.

(II) At intermediate voltages the situation is more complicated. At positive, intermediate voltages there could be a potential well, but separated from the bulk by a substantial potential barrier. The substantial potential barrier is several orders of magnitude larger than the thermal energy available at room temperature. More positive potentials make the well metastable, but still deep enough and separated by a barrier from the bulk, so that the nanoparticles can be trapped in such well for a long time. However, repulsion between nanoparticles can considerably reduce the height of the barrier and lead to their desorption from the interface. If the nanoparticles were initially in the bulk, the nanoparticles would never be able to overcome those barriers by thermal motion to reach the bottom of the well.

(III) The previous situation can cause strong hysteresis in adsorption-desorption. Indeed, when moving from large negative electric potentials, when the particle is localized in a region corresponding to the bottom of the well, to positive electric potentials, the energy splitting between the bottom of the well and the height of the barrier gradually decreases, and because of strong particle-particle repulsion there can be fewer and fewer particles trapped on the surface. But if the electric potential for positive values to the point where all the nanoparticles are dissolved in the bulk are varied, none of such nanoparticles can be able to reach the surface before the barrier essentially vanishes, but after that the concentration of nanoparticles on the surface can increase step-wise from zero to almost full monolayer coverage. It should be appreciated that reference is made to “almost” full coverage (e.g., substantially full coverage) because there can still be repulsion between the nanoparticles.

Large nanoparticles have a larger ratio of surface area to interface line than small nanoparticles, so the line tension is less significant for large nanoparticles. As described herein, voltages at which the large nanoparticles are trapped at the surface or are removed to the bulk can be large but still sustainable for the ITIES.

The Adsorption Isotherm

With the above approximations and simplifications, the energy profile is as shown in FIG. 2 for a single nanoparticle. However, when nanoparticles start to accumulate on the surface, the competition between the interaction among them and the single particle energy profile near the surface can determine the resulting coverage.

Since the nanoparticles under consideration generally are strongly negatively charged, the dominant term in their interaction is electrolyte-screened Coulomb repulsion. Accordingly, in scenarios in which the nanoparticles are strongly negatively charged, the adsorption isotherm show readily understandable features. The deeper the potential well, the larger the coverage. When there is an attraction there are additional effects—Van der Waals, capillary dimple-to-dimple attraction (the possibility to form dimples was completely ignored in the simplified picture of adsorption described herein), correlation forces in solutions of multiply charge ions—and the behavior becomes much more complicated, including potentially clustering, first order adsorption-desorption transitions or even more complicated phenomena. Generally the description of the adsorption isotherm can be obtained from the statistical mechanics of particle distributions on restructuring quasi-two-dimensional lattices. The absence of long range order may lead to a number of subtle phenomena, including Kosterlitz-Thouless transitions, as known to one of ordinary skill in the art (see also R. Zangi and S. Rice, Phys. Rev. E, 58, 7529 (1998), incorporated herein by reference). As derived above as Equation (1.16), a simpler adsorption isotherm, based on a simplified model of the interaction of nanoparticles at the interface is utilized herein. This adsorption isotherm reads:

$$- u = ln ( \frac{Γ}{1 - Γ} ) + \frac{{L}_{B} Z}{4 {a}^{5} {κ}^{4}} \cdot Γ \cdot {( 1 + \frac{κ a}{\sqrt{Γ}} )}^{2} exp ( - 2 κ a ( \frac{1}{\sqrt{Γ}} - 1 ) ) \qquad ( 1.17 )$$

Here, Γ is the coverage (e.g., the portion of the complete monolayer of nanoparticles), γ is the ratio of the maximum amount of nanoparticles that the bulk can accommodate to their maximum possible number in a monolayer at the interface, β is the portion of the total number of nanoparticles in the volume of the system to their number on the surface, Z is the average number of electrons on each nanoparticle (functionalized by ligands), L_{B} is the Bjerrum length (in water at room temperature, 0.7 nm), κ⁻¹ is the Debye length in water, a—nanoparticle radius, u is the energy difference between the barrier maximum and the minimum of the single particle well in the units of thermal energy, k_{B}T.

The single particle profile delivers for this isotherm the value of u, the quantity that varies with the bias voltage. Thus, solving this equation for Γ provides the plot displayed in diagram 300 of FIG. 3, which shows the dependence of Γ on the bias voltage. As explained above, this isotherm is valid if electric potentials increase from negative values to positive values; see curve 304. On the ‘way back’, namely, the electric potentials decrease from positive values to negative values, the curve can take another route: Γ can be zero until the negative potential at which the barrier vanishes, and then Γ can jump almost to the value of 1; see curve 308. The smearing of the step associated with the increase of Γ from zero to nearly 1 can be of the order of k_{B}T.

More particularly, FIG. 3 provides an example illustration of the interface coverage F (e.g., portion of a monolayer) by nanoparticles as a function of the energy splitting between the minimum of adsorption well and the maximum of the barrier given in the units of the thermal energy, −u, varying from left to the right—on the return route, Γ=0 up to substantially −u≈1.2·10⁻⁴ and then Γ increases sharply almost to 1. Calculation is performed for particles of 20 nm radius via Equation (1.17). Other parameters include: γ=2.5·10⁻⁵, qₙₚ=−1000|e|, and inverse Debye length in water κ=0.05 nm⁻¹.

These values can be used to show how the voltage can affect the reflection of light from the layer of such particles. Of course when the particles are desorbed from the surface they can not contribute measurably to the reflection from the bulk phase, which is also considered for comparison.

Note that the effect of β is negligible for the studied substantially deep wells. For such deep wells, the entropic effect, which should draw the particles away from the surface, becomes negligible.

### Dynamics of Adsorption-Desorption

Generally, a minute amount of nanoparticles, just enough to cover the surface, cannot be utilized to mitigate consumption of silver or gold and to warrant no coloring of the bulk. Rather, the maximum amount of nanoparticles for which the plasmon resonance can not shift in frequency in the bulk significantly can be utilized, and the nanoparticles can not aggregate. This is because of the dynamics of the response to changing voltage. Once the voltage changes there are two regimes for particle motion, and for both the speed of response of the system is sensitive to the nanoparticle concentration in bulk.

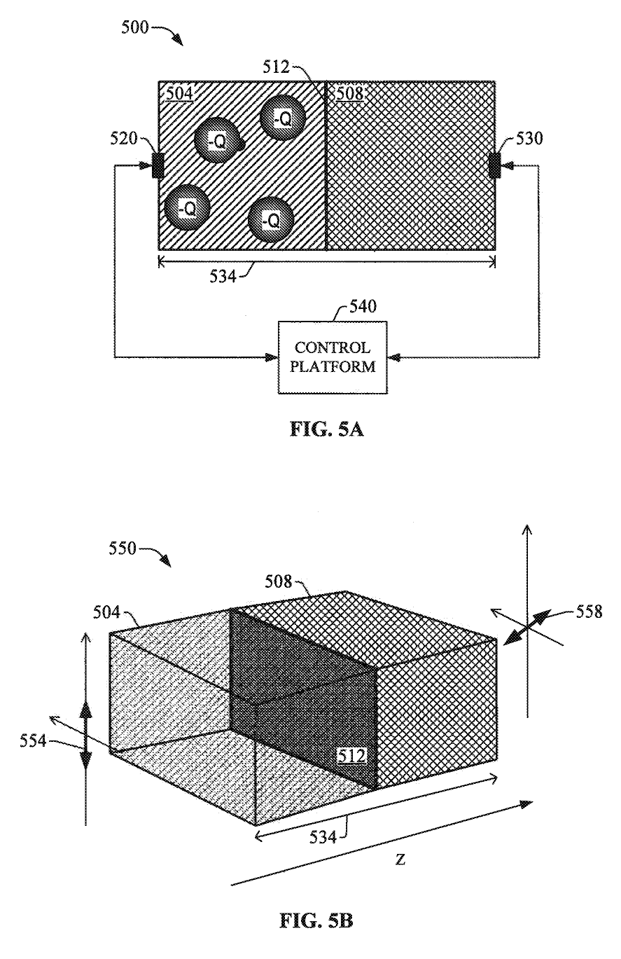

Initially the applied voltage is not screened in the fluid, and both ions and nanoparticles can drift. The length of time of this regime is determined by the time required to establish the screening double layer through ionic motion, τₛ=LL_{D}/Dᵢₒₙ, where L is the macroscopic dimension of the cell (see, e.g., FIG. 5, element 534), L_{D}=κ⁻¹ is the Debye screening length or its equivalent in a double layer nonlinearly responding to the overall voltage drop, and Dᵢₒₙ is the diffusion coefficient of the ions. The accumulation of nanoparticles at the interface would then be given by their bulk concentration times the drift velocity, V_{dr}, times τₛ. The drift velocity can be found from the diffusion constant of nanoparticles, Dₙₚ, and the Einstein relation, as V_{dr}=|qₙₚ|DₙₚV/Lk_{B}T, so the areal density accumulated during τₛ would be

$$σ ≡ \frac{1}{π {r}_{s}^{2}} = {c}_{np} {L}_{D} ( \vert {q}_{np} \vert V / {k}_{B} T ) ( {D}_{np} / {D}_{ion} ) ,$$

where rₛ is the radius of a sphere of a free area per one nanoparticle. The low nanoparticle diffusion constant relative to the ionic diffusion constant can be more than compensated for by the large value of |qₙₚ|V/k_{B}T. For a voltage of 0.5V and a nanoparticle charge of 1000, though lesser charge values are contemplated, a ratio of diffusion constants, Dₙₚ/Dᵢₒₙ, of 1:100, and L_{D}=20 nm, all nanoparticles within 2 micron of the interface can have drifted to the interface during the migration time, τₛ. Taking rₛ=40 nm, for a full interface coverage with 20 nm particles within the migration time, a bulk nanoparticle concentration of cₙₚ˜5×10¹⁶ particles/liter can be implemented. The migration time itself depends on the size of the cell, and for Dᵢₒₙ=10⁻⁵ cm²/s and a 1 cm cell (see, e.g., width 534 in example system 500), the migration time would be 0.2 second.

Once the applied voltage (or applied electric potential) is screened, the electric field can affect the nanoparticles only within the double layer region, and their transport to the surface can be determined by their diffusion from the bulk to the double layer. In this case, there is no enhancement from the large charge of the nanoparticle, and the time required to achieve a full coverage or nearly full coverage can be estimated as τ_{d}˜L²/Dₙₚ, where L=σ/cₙₚ the thickness of the liquid layer that includes enough nanoparticles to produce a monolayer when concentrated at the interface of a surface density σ. Accordingly, the necessary concentration cₙₚ=σ/\sqrt{τ_{d}D} that can provide a specific diffusion time can be estimated. Hence, for rₛ=40 nm, in order to cover the surface within about 1 s for nanoparticles of 20 nm radius and a diffusion coefficient, Dₙₚ˜10⁻⁷ cm²/s, cₙₚ=6×10¹⁶ particles/liter can be pursued or implemented.

As shown below for the bulk concentrations of nanoparticles, cₙₚ˜5×10¹⁶ particles/liter, which can correspond to response times from about 0.1 s to about 1 s for the adsorption-desorption process, the bulk solution could be slightly colored. For these concentrations, 20 nm Ag nanoparticles can contribute about 0.5% to the bulk reflection coefficient of the aqueous phase in the maximum of the reflection that lies at ω=3.25 eV (violet color). If it is desired to avoid coloring of the solution, a longer response time can be incurred. Yet, implementation scenarios of the various embodiments described herein can be directed to operation involing times shorter than about 1 s. Coloring of a solution comprising nanoparticles that drift towards an interface can be mitigated or avoided while preserving a response time below about 1 s by using materials for nanoparticles wherein such materials present an associated sharply-peaked surface plasmon resonance that lies outside the visible band of frequencies, and wherein such surface Plasmon resonance broadens sufficiently and shifts towards the visible band of frequencies in response to a coverage of nearly a monolayer at the interface. In certain embodiments, silver nanoparticles may be employed to achieved desired performance criteria. At intermediate voltages, strong hysteresis and pinning can take place. Moving from negative voltages with the particles sitting at the surface to intermediate voltages when the minimum becomes metastable, it can take the particle time to escape the metastable well determined by Brownian dynamics with the barrier. An estimate for this relaxation time may be given by the Kramers' escape-rate formula (H. A. Kramers, Physica, 7, 248 (1940), incorporated herein by reference):

$$\frac{1}{{τ}_{esc}} = \frac{m {Ω}_{min} {Ω}_{max}}{2 πη} exp \{ - u + 2 b θ + ln \frac{θ}{1 - θ} \} = \frac{m {Ω}_{min} {Ω}_{max}}{2 πη} \frac{θ}{1 - θ} exp \{ - u + 2 b θ \} \qquad ( 1.18 )$$

Here Ωₘᵢₙ and Ωₘₐₓ are the characteristic frequencies of small undamped oscillations: Ωₘᵢₙ is the frequency of oscillations about the metastable minimum of the potential well, whereas Ωₘₐₓ would be the frequency in a well corresponding to an inverted barrier maximum; m is the mass of nanoparticle; and η is liquid viscosity. Note that generally the prexponential factors can be of minor importance, as long as −u+2bθ<0 and |u−2bθ|>>1; in that case the switch time may be totally determined by the escape time and could be astronomically long. For this reason, it can be safer to avoid intermediate potentials for switching.

Optical Reflectivity of the Interface

In order to model optical properties of an ensemble of nanoparticles adsorbed at ITIES, an ordered system of metallic spheres is considered that occupy all sites of a two-dimensional lattice with a lattice constant a, which depends on the number of particles per unit area N. As described herein, the assumption of a crystalline structure of the adsorbed layer is well justified for the system under consideration, in which the characteristic energy of pairwise interactions between nanoparticles is much higher than the thermal energy. Within the dipole approximation the polarizability of a single sphere of radius R immersed in the aqueous phase with an optical dielectric constant ∈_{w} is given by

$${α}_{0} ( ω ) = {R}^{3} \frac{{ɛ}_{m} ( ω ) - {ɛ}_{w}}{{ɛ}_{m} ( ω ) + 2 {ɛ}_{w}} \qquad ( 2.1 )$$

where ω is the frequency of the light and ∈ₘ(ω) is the bulk dielectric constant of the metal that for silver and gold is well approximated by the Drude formula:

$${ɛ}_{m} ( ω ) = {ɛ}_{m} - \frac{{ω}_{p}^{2}}{ω ( ω + i δ )} \qquad ( 2.2 )$$

Here ∈ₘ is the dielectric constant of the valence electrons of the metal, ωₚ is the plasma frequency of metal electrons and δ is the damping constant.

Within the long wave-length approximation (qa, qR<<1, where q is a wave vector) that is relevant for consideration of light reflection, the frequency (ω) dependent components of the dielectric function of the interface—in the directions parallel (∥) and perpendicular (⊥) to the interface—with nanoparticles adsorbed on it, can be written in the form:

∈_{∥,⊥}(ω,z)=∈₀Θ(−z)+∈_{w}Θ(z)+4πnₛα_{∥,⊥}(ω)δ(z) (2.3)

Notations here are as follows, z is a coordinate normal to the interface (see, e.g., FIG. 5A) that is located at z=0,

$$Θ ( z ) = \{ \begin{matrix}1 , & z > 0 \\ 0 , & z < 0\end{matrix}$$

is the Heaviside step function and δ(z) is Dirac δ-function, ∈₀ is the optical dielectric constant of the oil, α_{∥,⊥}(ω) is the effective single-particle polarizability (affected by interactions between particles); this quantity is ∝R³ and it has dimensionality of the length-cubed, nₛ is the number of particles per unit surface area. The anisotropy of α_{∥,⊥}(ω) and ∈_{∥,⊥}(ω) is, primarily, due to the dipole-dipole interaction between the nanoparticles.

Neglecting quadrupole and higher-multipole contributions to the local electric field at the particles, the effective single-particle polarizability can be calculated as:

$$\begin{matrix}{α}_{\vert \vert} ( ω ) = \frac{{α}_{0} ( ω )}{1 - \frac{1}{2} {α}_{0} ( ω ) {a}^{- 3} U} & ( 2.4 ) \\ {α}_{⊥} ( ω ) = \frac{{α}_{0} ( ω )}{1 + {α}_{0} ( ω ) {a}^{- 3} U} & ( 2.5 )\end{matrix}$$

where

$$U = {a}^{3} {\sum }_{j ( j \neq 0 )}^{ } \frac{1}{{\vert {r}_{j}^{\vert \vert} \vert}^{3}} ,$$

and rⱼ^{∥} are the coordinates of nanoparticles on two-dimensional lattice and a is a characteristic lattice parameter for the two-dimensional lattice. For the square lattice we have U=9.03.

Considering the dielectric function in Equation (2.3), the reflection and transmission coefficients of light at ITIES covered by the nanoparticles can be found by matching electromagnetic fields at the interface z=0. Then for the reflection coefficient of the s-polarized light, it can be shown that

$${R}_{s} ( ω , ϕ ) = {\vert \frac{\sqrt{{ɛ}_{0}} cos ϕ - \sqrt{{ɛ}_{w} - {ɛ}_{0} {sin}^{2} ϕ} + 4 π i \frac{ω}{c} {n}_{s} {α}_{\vert \vert} ( ω )}{\sqrt{{ɛ}_{0}} cos ϕ + \sqrt{{ɛ}_{w} - {ɛ}_{0} {sin}^{2} ϕ} - 4 π i \frac{ω}{c} {n}_{s} {α}_{\vert \vert} ( ω )} \vert}^{2} \qquad ( 2.6 )$$

where φ and c are the angle of incidence and velocity of light. A similar equation can be derived for the reflection coefficient of the P-polarized light, and it is presented below.

### Reflection of S-Polarized and P-Polarized Light

A 2D-layer of nanoparticles may be characterized by an anisotropic dielectric tensor, ∈_{∥,⊥}^{l} whose components satisfy the relations:

$$\begin{matrix}{ɛ}_{\vert \vert}^{l} - {ɛ}_{w} = 4 π {n}_{s} {α}_{\vert \vert} / d , & ( 2.7 ) \\ \frac{1}{{ɛ}_{⊥}^{l}} - \frac{1}{{ɛ}_{w}} = - \frac{4 π {n}_{s} {α}_{⊥}}{d {ɛ}_{w}^{2}} & ( 2.8 )\end{matrix}$$

where d is an effective thickness of the layer of nanoparticles that can be put equal to the nanoparticle diameter, 2R. Then the reflection of light by such an anisotropic film embedded between the aqueous and organic phases can be calculated by matching electromagnetic fields at the boundaries of the layer. The resulting reflection coefficients for s- and p-polarized light read

$$\begin{matrix}{R}_{s} = {\vert \frac{2 ( {k}_{0} - {k}_{w} ) {k}_{\vert \vert}^{l} + ( {k}_{\vert \vert}^{l} - {k}_{w} ) ( {k}_{\vert \vert}^{l} + {k}_{0} ) ( exp ( 2 i {k}_{\vert \vert}^{l} d ) - 1 )}{2 ( {k}_{0} + {k}_{w} ) {k}_{\vert \vert}^{l} - ( {k}_{\vert \vert}^{l} - {k}_{w} ) ( {k}_{\vert \vert}^{l} - {k}_{0} ) ( exp ( 2 i {k}_{\vert \vert}^{l} d ) - 1 )} \vert}^{2} & ( 2.9 ) \\ {R}_{p} = {\vert \frac{\begin{matrix}2 ( {ɛ}_{0} {k}_{w} - {ɛ}_{w} {k}_{0} ) {k}_{⊥}^{l} + ( {k}_{w} {ɛ}_{\vert \vert}^{l} - {ɛ}_{w} {k}_{⊥}^{l} ) ( {k}_{0} + {ɛ}_{0} {k}_{⊥}^{l} / {ɛ}_{\vert \vert}^{l} ) \\ ( exp ( 2 i {k}_{⊥}^{l} d ) - 1 )\end{matrix}}{\begin{matrix}2 ( {ɛ}_{0} {k}_{w} - {ɛ}_{w} {k}_{0} ) {k}_{⊥}^{l} - ( {k}_{w} {ɛ}_{\vert \vert}^{l} - {ɛ}_{w} {k}_{⊥}^{l} ) ( {k}_{0} - {ɛ}_{0} {k}_{⊥}^{l} / {ɛ}_{\vert \vert}^{l} ) \\ ( exp ( 2 i {k}_{⊥}^{l} d ) - 1 )\end{matrix}} \vert}^{2} \\ where \\ {k}_{o} = \frac{ω}{c} \sqrt{{ɛ}_{o}} {cos}^{2} θ , {k}_{w} = \frac{ω}{c} \sqrt{{ɛ}_{w} - {ɛ}_{o} {sin}^{2} θ} , \\ {k}_{\vert \vert}^{l} = \frac{ω}{c} \sqrt{{ɛ}_{\vert \vert}^{l} - {ɛ}_{0} {sin}^{2} θ} , \\ {k}_{⊥}^{l} = \frac{ω}{c} {( \frac{{ɛ}_{\vert \vert}^{l}}{{ɛ}_{⊥}^{l}} )}^{1 / 2} \sqrt{{ɛ}_{⊥}^{l} - {ɛ}_{0} {sin}^{2} θ} & ( 2.10 )\end{matrix}$$

It should be noted that in the limit of optically thin layer of nanoparticles,

$$\frac{ω}{c} {k}_{\vert \vert , ⊥}^{l} d << 1 ,$$

the reflection coefficients given by Equations (2.9)-(2.10) are independent of the layer thickness, d, and determined by the single-particle polarizabilities, α_{∥} and α_{⊥}. In this limit, Eq. (2.9) for the reflection of the S-polarized light is reduced to Eq. (2.6).

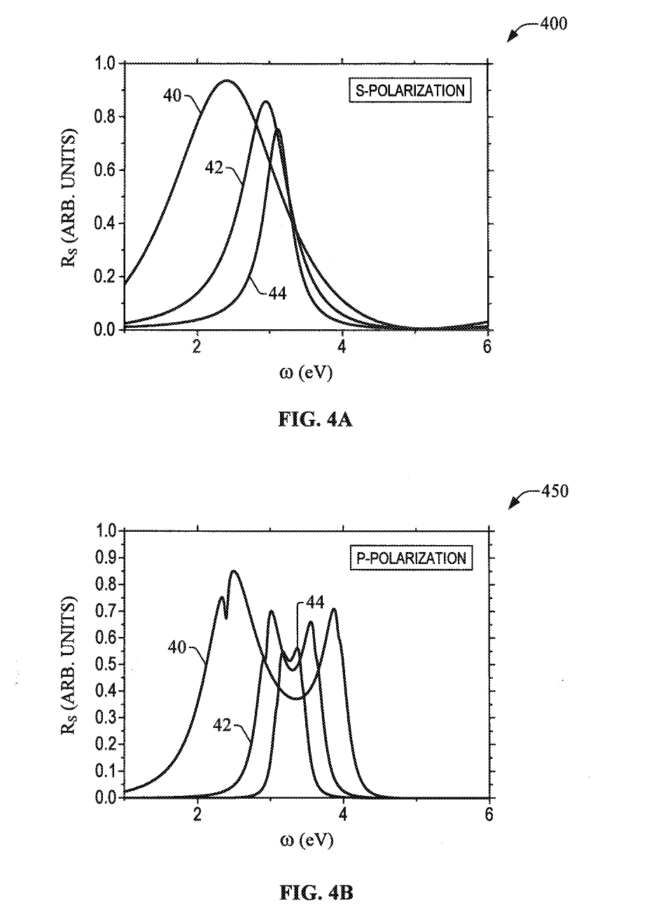

Results of calculations of reflection coefficients presented in FIG. 4 show that a monolayer of silver nanoparticles of the radius 20 nm localized at ITIES provides more than 40% reflectivity in a wide range of light frequencies, 1.5 eV<ω<3.5 eV. With decrease of nanoparticle coverage, the range of high reflectivity is reduced and shifted to higher frequencies.

FIGS. 4A-4B illustrate frequency dependence of the coefficient of reflection of electromagnetic wave from the aqueous/1,2 dichloroethane solution interface covered by silver nanoparticles. Incident wave comes from the organic electrolyte phase. Calculations performed for 20 nm radius particles. The results are shown for three different coverages: Γ=1.000, illustrated in curve 40; Γ=0.570, illustrated in curve 42; and Γ=0.335, illustrated in curve 44. Following the adsorption isotherm for 20 nm particles and 1000 electron charge of the ligands on each particle, such coverages correspond to three different depth of the trapping well: u=−2×10⁴k_{B}T (corresponding to curve 40); u=−0.6×10⁴k_{B}T (corresponding to curve 42); and u=−0.2×10⁴k_{B}T (corresponding to curve 44). In turn, these three depths of the well, subject to the basic model of localization of nanoparticles across the interface, correspond to voltages across the interface V/k_{B}T=30 (corresponding to curve 40), V/k_{B}T=12.3 (corresponding to curve 42), and V/k_{B}T=5.7 (corresponding to curve 44). Angle of incidence, φ=45°. In FIGS. 4A and 4B incident light is, respectively, S-polarized and P-polarized.

FIGS. 4A-4B demonstrate that the frequency dispersion of the reflection coefficient for S-polarized and P-polarized light is substantially different. In contrast to the one-broad-peak structure for the S-polarized light, in the case of P polarization two distinct peaks are identifiable. Both peaks have signatures of satellite peaks that overlap with the main ones and at low density of nanoparticles are seen as mild shoulders. This multi-peak structure has a subtle nature; such structure can be determined by the effect of interaction between nanoparticles on the frequency and width of the surface plasmon resonance. Indeed, the interaction leads to a red shift of the plasmon mode parallel to the interface (∥) and to the blue shift of the mode perpendicular to the interface (⊥). As a result, the reflection coefficient of the s-polarized light that excites only the ∥-mode exhibits the red-shifted peak only, while the reflection of the p-polarized light exciting both the ∥-mode and ⊥-mode present two peaks corresponding to the red and blue-shifted resonances of individual particles. The results presented in FIGS. 4A and 4B have been obtained for an ordered layer of nanoparticles. The effect of disorder gives rise to an additional broadening of the plasmon resonances in a layer, which is generally beneficial for the mirror-effect, but does not change the above conclusions.

Whatever the frequency dispersion, the large value of reflection coefficient when the nanoparticles are localized at the interface, relative to the case when the nanoparticles are homogeneously dispersed in the bulk of at least one of a first medium (e.g., aqueous phase 110) or a second medium (e.g., oily phase 120), has a clear origin. The large value of the reflection coefficient is due to the effects of phase coherence of scattered waves from nanoparticles at the interface (e.g., interface 124) and in the strong interaction between the nanoparticles. To be able to exploit the large value of the reflection coefficient, the surface coverage should be close to a full monolayer. Specific extent to which the surface coverage should be close to a full monolayer can be generally dictated by specific application; for instance, a first interface the operates as a mirror can have a first surface coverage of nanoparticles that is smaller than a second surface coverage of nanoparticles of a second interface that operates as a light filter; yet, both the first coverage and the second coverage can be close to a full monolayer coverage. It should be noted that when all nanoparticles are desorbed from an ITIES (e.g., interface 124) and located in the aqueous phase (e.g., aqueous phase 110), the reflection coefficients can be calculated using the Fresnel equations where the dielectric constant of the aqueous phase, including nanoparticles, is determined by the Maxwell-Garnet equation, as known to one of ordinary skill in the art. There are other approximations and high densities of impurities, such as, for example, the popular Bruggeman rule. The corresponding Maxwell-Garnet calculations are shown below.

### Fresnel Reflection (a Maxwell-Garnet Estimate)

When all the particles are desorbed from ITIES and located in the aqueous phase, the Maxwell-Garnet equation can be used to estimate the effect of nanoparticles on the dielectric constant of this phase. Within the Maxwell-Garnet approximation the optical dielectric constant of the aqueous phase in the presence of nanoparticles, ∈_{w+np}, can be written as

$${ɛ}_{w + np} = {ɛ}_{w} \frac{2 {ɛ}_{w} ( 1 - v ) + {ɛ}_{m} ( 1 + 2 v )}{{ɛ}_{m} ( 1 - v ) + {ɛ}_{w} ( 2 + v )} \qquad ( 3.1 )$$

where

$$v = \frac{4}{3} π {R}^{3} n$$

and n is a volume density of the nanoparticles in the aqueous phase. Then the reflection coefficients of light are given by Fresnel equations with the dielectric constant of the aqueous phase described by Equation (3.1). For instance, the reflection coefficient of the p-polarized light has the following form

$${R}_{p}^{b} = {\vert \frac{{ɛ}_{o} \sqrt{{ɛ}_{w + np} - {ɛ}_{o} {sin}^{2} θ} - {ɛ}_{w + np} \sqrt{{ɛ}_{o}} cos θ}{{ɛ}_{o} \sqrt{{ɛ}_{w + np} - {ɛ}_{o} {sin}^{2} θ} + {ɛ}_{w + np} \sqrt{{ɛ}_{o}} cos θ} \vert}^{2} \qquad ( 3.2 )$$

As we discussed above, in order to obtain the response time of the ensemble of nanoparticles to changing voltage that lies that in the range of a second, the average distance between the nanoparticle should be not larger than approximately 100 times the size(s) of the nanoparticles. This gives ν≈10′. Equations (3.1)-(3.2) show that under such condition the effect of silver nanoparticles located in the aqueous phase (e.g., aqueous phase 110) on the reflection coefficient at ITIES (e.g., interface 124) is smaller than 10⁻⁴. The latter shows that for reasonably small bulk concentrations of nanoparticles that allow to coat with nanoparticles or inject nanoparticles into the interface surface within less than about 1 s, the effect of such concentrations on reflectivity is smaller than 10⁻⁴. Thus changing the electric potential bias (or electric potential difference) from nearly 25 mV to about −50 mV, which allows a transition from the full monolayer coverage of nanoparticles to a free interface, results in reversibly tuning the reflectivity of ITIES between a mirror like, achieving at, e.g., V=25 mV no less than 40% reflectivity in the whole visible spectrum, and complete transparency at, e.g., V=−50 mV.

One or more example embodiments described herein are illustrated with an example system 500—depicted in FIG. 5—for control of optical properties of an interface between two immiscible media. In FIG. 5, the example system 500 is illustrated in a cross-sectional view. Example system 500 includes a first medium 504 and a second medium 508, wherein the first medium 504 and the second medium 508 are immiscible. As illustrated, a plurality of nanoparticles (pictorially depicted with four grey circles with a label −Q, which represents the charge of an associated nanoparticle) can be dispersed within the first medium 504. However, it should be appreciated that energetic considerations such as those described hereinbefore can determine that the plurality of nanoparticles can be dispersed primarily in the second medium 508. In certain embodiments, the first medium can be a first electrolytic solution (e.g., the aqueous phase 110, see FIG. 1A) and the second medium 508 can be a second electrolytic solution (e.g., the oily phase 120; FIG. 1A), wherein both the first electrolytic solution and the second electrolytic solution can be substantially transparent to visible light. In alternative or additional embodiments, the first medium can be a liquid phase (e.g., the aqueous phase 110) and the second medium 508 can be a solid phase (e.g., an ITO film or slab). The plurality of nanoparticles serves as a source of nanoparticles that can be localized at the interface 512 between the first medium 504 and the second medium 508 (see also FIG. 1B) in response to application of an electric potential difference amongst the first medium 504 and the second medium 508.

A first electrode 520 functionally coupled (e.g., attached) to the first medium 504 and a second electrode 530 functionally coupled (e.g., attached) to the second medium 508 can enable, at least in part, application of the electric potential difference across the interface 512. In addition, example system 500 can comprise a control platform 540 which can supply the electric potential difference by applying a first electric potential to the first electrode 520 and a second electric potential to the second electrode 530. Control platform 540 can apply specific first and second electric potential differences in accordance with at least one control criterion (a schedule, an event-based threshold, etc.), which can be configurable and retained in a memory (or any computer-readable or machine-readable storage medium) within the control platform 540 or functionally coupled thereto. Moreover, the at least one control criterion can be part of control logic (e.g., specific computer-executable instructions, such as computer programming code instructions) retained in the memory (not shown). A processor (not shown) that, in one or more embodiments, is part of control platform 540 can execute the control logic to achieve a configured or desired variation of the electric potential difference. Furthermore, control platform 540 can include a voltage supply (not shown) the applies the first electric potential (e.g., a first voltage) to the first electrode 520 and the second electric potential (e.g., a second voltage) to the second electrode 530 to achieve the electric potential difference. Control platform 540 thus can comprise various electric circuitry that enables the various features or aspects described herein, such as, for example, execution of control logic, selection of a specific electric potential difference, selection of voltage(s), application of such voltage(s), and the like.

In one example, for silver spheres in the bulk of aqueous solution, the reflection peak in reflection coefficient lies at 3.25 eV (or 381 nm), that is violet. Definition of the visible range of electromagnetic (EM) radiation wavelengths varies, but conventionally it refers to the interval from 380 nm to 750 nm. Accordingly, the plasmon peak of silver spherical particles in the bulk is located just at the boundary—e.g., some human eyes may see the window slightly colored. However, certain textbooks define the visible range as corresponding to the interval of EM radiation wavelengths from 400 to 700 nm; if so, the mentioned plasmon peak lies outside this range. The difference can most likely be unnoticeable, since in both cases very small absolute values of the reflection coefficient are described, of the order of 1-2%. In other aspects, alloys, or even multilayer nanoparticles, for example, nanoparticles in a core-shell configuration, can be employed. In all these searches, however, a restriction may be imposed: Materials with large dissipation (large δ in Eq. (2.2)), such as, e.g., aluminum typically can be excluded because the mirror then can absorb light instead of reflecting it.

In terms of applications, a smart window that can be opened or closed for light by approximately 1 V voltage variation can be advantageous, particularly in countries with a hot climate. It is known that except for the West Coast and Northern States, in U.S. the amount of energy spend on cooling air in summer exceeds the amount spend on heating in winter. The same is true for rich countries in the Middle East and developing South Asia. Using embodiments described herein, a sensor counts when the last person leaves the office, turns on the proper voltage and converts a window into a mirror, and turns it off with the first person entering it. That can save energy wasted on air-conditioning, for the time when no one is in the office. In an embodiment, the sensor can be part of control platform 540.

Described herein are embodiments based on self-assembling of nanoparticles at an interface (liquid/liquid or liquid/solid), which does not contain expensive materials. Indeed, for a monolayer of coated 10 nm Au nanoparticles, the price is roughly 1 Cent/m². Furthermore, the electrochemical system embodiments described herein do not require a current passage for the creation of an ohmic drop, as the reflection takes place at the interface and the bulk is not important.

In one aspect utilizing embodiments of ITIES-based architecture described herein in a smart window application, a vertical interface can be created. In this embodiment, a thin film liquid-liquid system can be imbedded between highly hydrophilic and highly hydrophobic glasses. The energy benefits to aqueous phase to contact the hydrophilic glass and oil phase the hydrophobic glass must overweigh the water/oil contact energy. It should be appreciated that creation of a vertical interface is not problematic for embodiments of micro-fluidic optical switches that can be based on the mirror effect of the subject disclosure.

Alternatively, other aspects comprise an indium tin oxide (ITO) electrode in contact with aqueous electrolyte with dissolved negatively charged nanoparticles. For a corresponding positive electrode polarization, nanoparticles can be on the surface of the electrode, whereas at negative polarizations they can be expelled to the bulk. The other side of the cell comprises a dielectric glass with implanted mini-electrode, in order not obscure the transparency of the dielectric glass when nanoparticles are expelled from the first electrode to the second one.

Another aspect comprises manipulating the system parameters, e.g., by tuning the charge on the nanoparticle through the variation of pH, in such a way, that at zero polarization, nanoparticles tend to remain in the bulk, moving to either of the electrodes with negative or positive polarization. Under this condition, both sides of the cell can be made of ITO. A sufficient voltage of any sign between the two electrodes turns the transparent window into a mirror. As indicated previously, specific extent to which a voltage is a sufficient voltage can be generally dictated by specific application of the interface between two immiscible media. Furthermore, the two parallel ITO plates can be connected and comprise one electrode. The counter electrode can be positioned away from the light-beam, on a side. All that would matter then, would be moving nanoparticles from the ITO electrode surface to the counter electrode and vice versa.

Another aspect comprises ITIES (e.g., example embodiment 100) or ITO electrodes (e.g., electrode 520 is an ITO electrode or electrode 530 is an ITO electrode) involving magnetic nanoparticles (yttrium iron garnet (YIG), iron, cobalt, etc.) that allows electric-field-controlled magnetism (e.g., control of magnetic phase transitions not by temperature but via the coverage dependent coupling constant) and voltage controlled magneto-optical effects. The latter provides avenues for optical polarizers based on Faraday rotation and voltage-controlled semi-transparent ‘Janus’ windows.

Faraday rotation is a magneto-optical effect. Conventionally, Faraday rotation refers to rotation of the polarization of a beam of light propagating through a dielectric medium in response to application of an external magnetic field along the direction of propagation of the beam of light. Faraday rotation can be quantified by an angle-of-rotation of a polarization vector. In contrast, in the subject disclosure, rotation of the polarization of a beam of light incident onto an interface between two immiscible media can be achieved without application of an external magnetic field to a first-medium-second-medium composite material, wherein the first medium and the second medium are immiscible media. In an aspect, such rotation of the polarization of the beam of light can be effected by localization of magnetic nanoparticles at the interface (e.g., interface 512) between the first medium (e.g., medium 504) and the second medium (e.g., medium 508) in response to application of an electric field potential bias (or difference) across such interface. In another aspect, rotation of the polarization of the beam of light can originate in off-diagonal terms in the dielectric permittivity tensor of the material of the magnetic nanoparticles. Such off-diagonal terms effective cause an ordinary (or, for example, left handed) propagating beam of light and an extraordinary (or, for example, right handed) propagating beam of light. Rotation of the polarization of the beam of light is a magneto-optical effect and thus is referred to as Faraday rotation. As an illustration, FIG. 5B presents a diagram 550 the depicts a perspective representation of example system 500. Diagram 550 also presents an initial polarization vector 554 of a light beam that can be rotated into a final polarization vector 558 after the light beam propagates through media 504 and 508, crossing interface 512, as a result of the magneto-optical effects described herein. In an aspect, maximal Faraday rotation effect is represented by an angle-of-rotation of π/4.

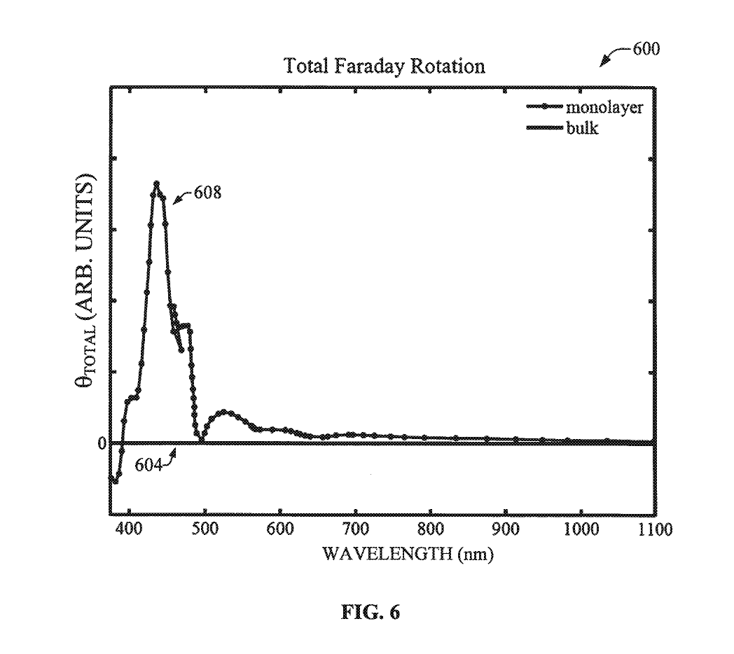

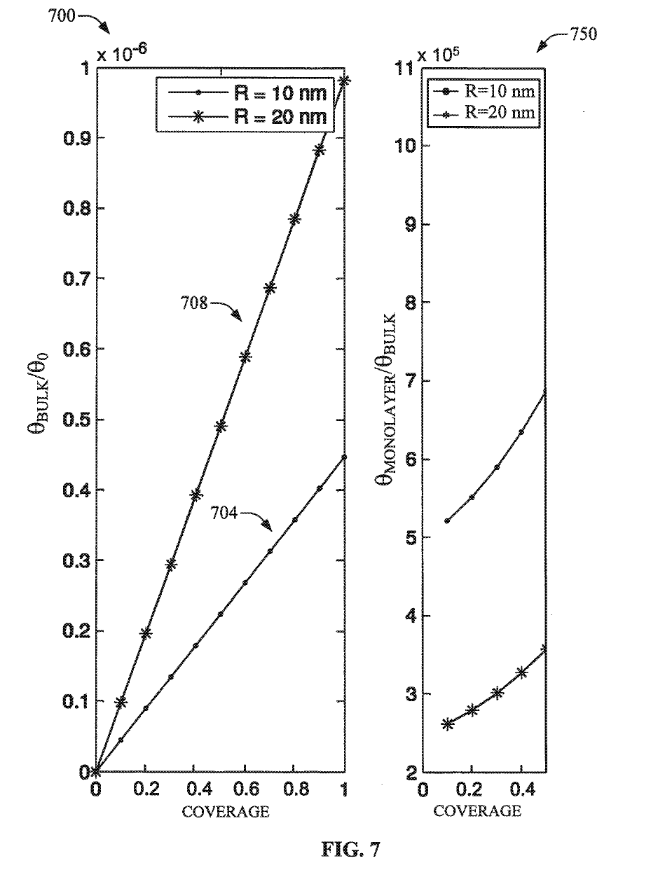

Regarding Faraday rotation caused through localization of magnetic nanoparticles in a system comprising a first medium (e.g., aqueous phase 110) and a second medium (e.g., an oily phase 120 or ITO) that are immiscible media and thus form an interface (e.g., interface 124 or interface 512), FIG. 6 presents a diagram 600 of total Faraday rotation as a function of EM radiation wavelength for YIG nanoparticles of radius R for two example scenarios: (1) nanoparticles dispersed in bulk of at least one of the first medium (e.g., aqueous phase 110) or the second medium (e.g., an oily phase 120 or ITO); and (2) nanoparticles localized at the interface (e.g., interface 124 or interface 512). Example scenario (1) can be achieved through application of a suitable electric potential difference across the interface, wherein the suitable electric potential difference does not cause localization of the magnetic nanoparticles at the interface between the first medium and the second medium. In example scenario (1), the total Faraday rotation is conveyed by curve 704, which displays a substantially null angle-of-rotation for the studied wavelengths, particularly those wavelengths corresponding to the visible portion of the visible spectrum of EM radiation (e.g., from nearly 380 nm to nearly 750 nm). In contrast, scenario (2) can be achieved through application of a suitable electric potential difference across the interface between the first medium (e.g., aqueous phase 110) and the second medium (e.g., oily phase 120) that causes localization of at least a portion (e.g., a specific surface coverage) of a plurality of magnetic nanoparticles at the interface of the first medium (e.g., aqueous phase 110) and the second medium; the plurality of magnetic nanoparticles are dispersed in at least one of the first medium or the second medium. Curve 708 conveys the total Faraday rotation in scenario (2): The angle-of-rotation (θ) displays a broad peak with a maximum in the vicinity of 440 nm and satellite structures at about 470 nm, 520 nm, 600 nm, and 680 nm. Accordingly, localization of magnetic nanoparticles at the interface between the first medium and the second medium results in substantial variation on the polization of light incident onto such interface.

In certain scenarios, the angle-of-rotation θ=θₜₒₜₐₗ, where

$${θ}_{total} = {θ}_{Bulk} + {θ}_{monolayer} = \frac{π \overline{n}}{λ} {θ}_{0} ( 2 R ) Φ \qquad ( 4.1 )$$

where Φ is an dimensionless coefficient, and 2R is the diameter of the magnetic nanoparticles that cover or are concentrated in the interface between the first medium and the second medium. In an aspect, 2R represents the thickness of a full monolayer of the magnetic nanoparticles at the interface. Other quantities in Eq. (4.1) are defined below. In another aspect, Φ can be derived from the definitions provided below.

FIG. 7 presents a diagram 700 of dimensionless Faraday rotation power θ_{Bulk}/θ₀ of magnetic nanoparticles (e.g., YIG) dispersed in bulk of at least of a first medium (e.g., aqueous phase 110) or a second medium (e.g., oily phase 120) in the presence, or as a function, of coverage (F) of magnetic nanoparticles at the interface between the first medium and the second medium. In the subject disclosure, θ_{Bulk} is the Faraday angle-of-rotation (also referred to as Faraday rotation) for magnetic nanoparticles dispersed in the bulk of the first medium (e.g., aqueous phase 110). In an aspect,

$${θ}_{Bulk} = \frac{3 {ɛ}_{w} {ɛ}_{d} {θ}_{0}}{[ {ɛ}_{d} - {ɛ}_{w} + \frac{L}{4 π {n}_{s} {R}^{3}} {ɛ}_{M} ( {ɛ}_{d} + 2 {ɛ}_{w} ) ] ( {ɛ}_{d} + 2 {ɛ}_{w} )} \qquad ( 4.2 )$$

where θ₀ is an angle-of-rotation normalized to a length of a straight path across and normal to the interface between the first medium and the second medium, and

$${θ}_{0} = \frac{λ}{π \overline{n} L} {θ}_{F} ,$$

wherein L is the dimension of the first-medium-second-medium composite in the direction normal to the interface (e.g., interface 512) between the first medium and the second medium, and wherein λ is the wavelength of light incident onto such interface, and wherein n̅ is the average of a first refractive index (n_{L}) for a first polarization (e.g., left-handed polarization) and a second refractive index (n_{R}) for a second polarization (e.g., right-handed polarization) orthogonal to the first polarization, and further wherein

$${θ}_{F} = \frac{π L}{λ} ( {n}_{L} - {n}_{R} )$$

and is the measured angle-of-rotation for the material of the magnetic nanoparticles. In an embodiment, for certain materials, n̅ is nearly equal to \sqrt{12}; however, other values are also contemplated in the subject disclosure. In certain embodiments, n̅ is approximately \sqrt{∈_{d}}. In certain embodiments, L can be nearly 10⁷ nm (or 1 cm; see, e.g., width 534 in example system 500). In additional or alternative embodiments, L can adopt values that are larger or smaller than 1 cm. In the subject disclosure, the angle-of-rotation θ₀ also is referred to as the dimensionless rotation power of such bulk. In one or more embodiments, θ₀ ranges from about 10⁻⁴ to about 10⁻³ in the interval of light wavelengths ranging from nearly 400 nm to nearly 500 nm.

In addition, in Eq. (4.2), nₛ is the concentration (e.g., number of particles per unit surface) of magnetic nanoparticles at the interface and nₛ=Γ/2\sqrt{3}(R+ξ)² with ξ represents an effective thickness of the interface (e.g., interface 512) between the first medium and the second medium and R the radius of spherical magnetic nanoparticles, wherein in some embodiments ξ is approximately 1 nm; and a is α polarizability coefficient α=Γ^{3/2}ŪR₃/2 wherein Ū a geometric coefficient that depends on particular arrangement of the magnetic nanoparticles at the interface between the first medium (e.g., aqueous phase 110) and the second medium (e.g., oily phase 120). As an example, for a square lattice of particles (e.g., non-magnetic nanoparticles or magnetic nanoparticles) Ū=9.03a⁻³ wherein a is the lattice parameter of the square lattice. As another example, for a hexagonal lattice of particles (e.g., non-magnetic nanoparticles or magnetic nanoparticles) Ū=11.03g⁻³ wherein g is the lattice parameter of the hexagonal lattice. It should be appreciated that g is related to nₛ; in an aspect,

$$g = {( \frac{1}{{n}_{s} \sqrt{3}} )}^{1 / 2} .$$

Furthermore, ∈_{d} is the static dielectric constant relative to vacuum permittivity of the material of the magnetic nanoparticles; ∈_{w} is the static dielectric constant relative to vacuum permittivity of a medium (e.g., aqueous phase, such as water) displaced by a magnetic nanoparticle; and ∈_{M} is the static dielectric constant relative to vacuum permittivity of a medium (e.g., aqueous phase, such as water) in which the magnetic nanoparticles are dispersed. In common, yet not exclusive, embodiments, ∈_{M} is equal or substantially equal to ∈_{w}. In typical, yet not exclusive embodiments, ∈_{d}≈12, ∈_{w}=1.77, and ∈_{M} is substantially equal to ∈_{w}; other values of such quantities are also contemplated.

Diagram 700 presents results for spherical YIG nanoparticles with radii 10 nm (curve 704) and 20 nm (curve 708). The coefficient θ_{Bulk}/θ₀ increases nearly linearly with coverage for both nanoparticle sizes. In an aspect, for the various parameters employed to generate diagram 700, θ_{Bulk}/θ₀ is nearly equal to 5·10⁻⁷ for Γ=1 and R=10 nm. Also presented in FIG. 7 is a diagram 750 of the ratio of dimensionless Faraday rotation power (θ_{monolayer}/θ₀) of magnetic nanoparticles localized at the interface between the first medium and the second medium and θ_{Bulk}/θ₀. In an aspect,

$${θ}_{monolayer} = \frac{3 {ɛ}_{w} {ɛ}_{d} {θ}_{0}}{\begin{matrix}[ {ɛ}_{d} - {ɛ}_{w} + \frac{1 - π {n}_{s} {R}^{2}}{2 π {n}_{s} {R}^{2}} {ɛ}_{M} ( {ɛ}_{d} + 2 {ɛ}_{w} - L ( {ɛ}_{d} - {ɛ}_{w} ) ) ] \\ ( {ɛ}_{d} + 2 {ɛ}_{w} - L ( {ɛ}_{d} - {ɛ}_{w} ) )\end{matrix}} \qquad ( 4.3 )$$

As illustrated, dimensionless Faraday rotation power of magnetic nanoparticles localized at such interface is several orders of magnitude larger than that of magnetic nanoparticles dispersed in the bulk of at least the first medium or the second medium. Spherical magnetic nanoparticles with radius of 10 nm provide a larger enhancement of the dimensionless Faraday rotation power than that of spherical magnetic nanoparticles with radius of 20 nm. While results in diagram 750 are presented for surface coverage ranging from 0 to about 0.5 monolayer, the values of θₘₒₙ/θ_{Bulk} continue to increase monotonically with coverage. In an aspect, for the various parameters employed to generate diagram 750, θ_{monolayer}/θ₀ is nearly equal to 2·10⁻³ for Γ=1 and R=10 nm.

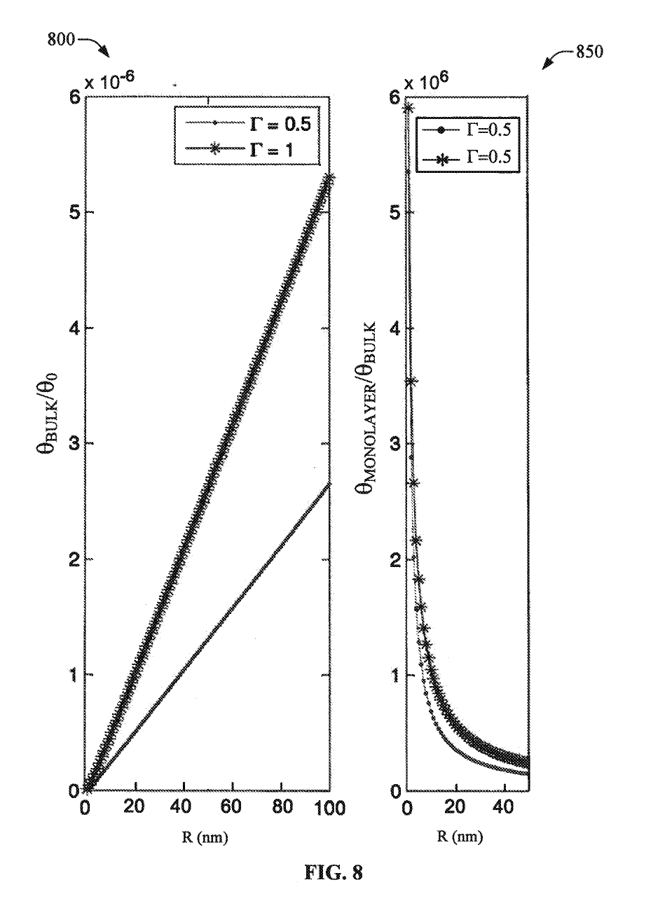

FIG. 8 presents diagrams 800 and 850 which depict, respectively, θ_{Bulk}/θ₀ and θ_{monolayer}/θ_{Bulk} at predetermined values of surface coverage as a function of radius of the magnetic nanoparticles that are dispersed in the bulk of at least one of the first medium or the second medium. While θ_{Bulk}/θ₀ increases with the radius of the magnetic nanoparticles, θ_{monolayer}/θ_{Bulk} decreases as such radius increases. In an aspect, as the magnetic nanoparticles become larger, plasmonic excitations associated with light incident in the interface have a lesser effect on enhancement of magnetic coupling amongst magnetic nanoparticles localized at the interface and thus θₘₒₙ/θ_{Bulk} decreases. As described hereinbefore in connection with FIG. 7, larger coverage Γ results in larger values of θ_{Bulk}/θ₀ and θₘₒₙ/θ_{Bulk}.

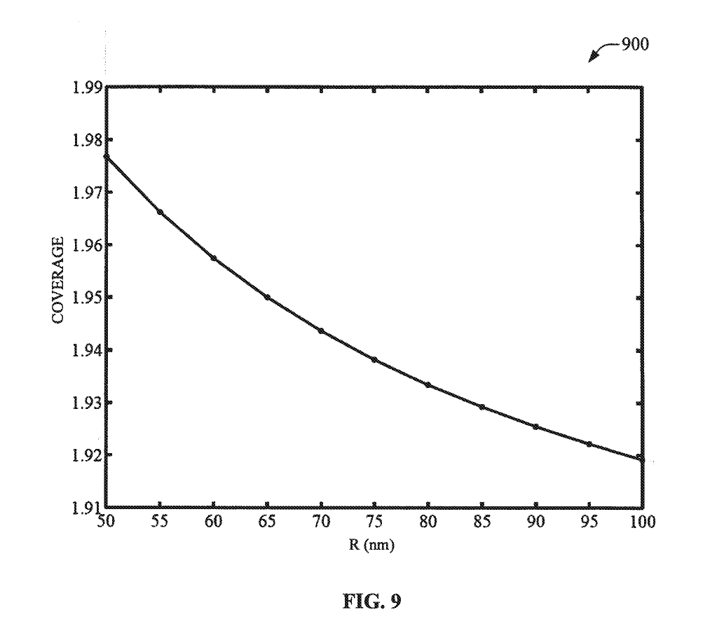

FIG. 9 illustrates a plot 900 of coverage of magnetic nanoparticles at an interface between a first medium (e.g., a first electrolytic solution) and a second medium (e.g., a second electrolytic solution) as a function of characteristic size (e.g., radius of spherical nanoparticles) of the magnetic nanoparticles in accordance with aspects of the subject disclosure, wherein the illustrated coverage provides maximal Faraday rotation power. The coverage presented in plot 900 decreases as the characteristic size (e.g., radius) of the magnetic nanoparticles increases.

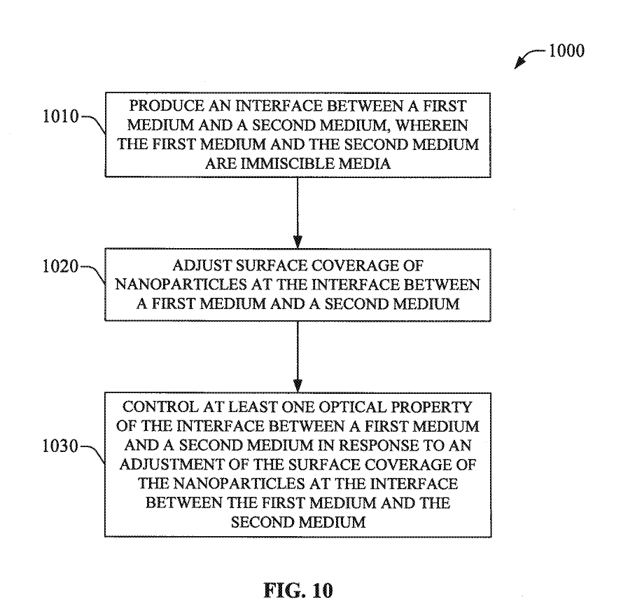

In view of the various example systems and related embodiments described hereinbefore, an example method that can be implemented in accordance with various aspects, features, or advantages of the subject disclosure can be better appreciated with reference to the flowchart of FIG. 10. While, for purposes of simplicity of explanation, the example methods described herein are shown and described as a series of acts, it is to be understood and appreciated that the disclosed subject matter is not limited by the number or order of acts, as some acts may occur in different orders and/or concurrently with other acts from what is depicted and described herein. Moreover, not all illustrated acts may be required to implement the example methods described herein. It is to be appreciated that the functionality associated with the acts may be implemented by software, firmware, hardware, a combination thereof or any other suitable means (e.g., device, system, process, component).

FIG. 10 depicts a flowchart of an example method for controlling optical properties of an interface between at least two immiscible media according to aspects of the subject disclosure. At act 1010, an interface between a first medium and a second medium is produced, wherein the first medium and the second medium are immiscible media and substantially transparent to visible light. As described herein, in certain embodiments, the first medium can be a first electrolytic solution and the second medium can be a second electrolytic solution. In an aspect, the first electrolytic solution can be an aqueous phase comprising inorganic ions, and substantially transparent to visible light, and the second electrolytic solution can be an oily phase comprising organic ions, and substantially transparent to visible light.

At act 1020, surface coverage of nanoparticles at the interface between the first medium and the second medium can be adjusted. A plurality of nanoparticles dispersed in at least one of the first medium or the second medium can be a source of the nanoparticles. In certain embodiments, based on energy balance considerations, the plurality of nanoparticles is preferentially, yet not exclusively, dispersed within the first medium (e.g., an aqueous phase). In alternative or additional embodiments, the plurality of nanoparticles can be dispersed within the second medium (e.g., an oily phase), yet not exclusively. The plurality of nanoparticles comprises one or more of non-magnetic nanoparticles (gold, silver, tungsten, etc.) or magnetic nanoparticles (e.g., yttrium iron garnet). Moreover, the plurality of nanoparticles can comprise symmetric nanoparticles or asymmetric nanoparticles, and in certain embodiments a mixture of symmetric nanoparticles (spheres, ellipsoids, tetrahedral, octahedral, etc.) and asymmetric nanoparticles (e.g., distorted spheres, distorted ellipsoids, distorted tetrahedral, distorted octahedral, disordered nanoparticles, etc.) can compose the plurality of nanoparticles. Adjusting the surface coverage of the nanoparticles at the interface between the first medium and the second medium can comprise applying an electric potential difference between the first medium and the second medium. The electric potential difference can adopt several suitable values—e.g., values that cause localization of nanoparticles at the interface between the first medium and the second medium and cause the surface coverage to be adjusted. Accordingly, in an aspect, applying such electrical potential difference includes, but is not limited to, maintaining the electric potential difference below about one volt. In another aspect, applying such electrical potential difference includes, but is not limited to, maintaining the electric potential difference above or at about one volt. In yet another aspect, applying such electrical potential difference includes, but is not limited to, maintaining the electric potential difference at one volt.

At act 1030, at least one optical property of the interface between the first medium and the second medium is controlled in response to an adjustment of the surface coverage of the nanoparticles at such interface. In an aspect, controlling the at least one optical property comprises rendering the interface between the first medium and the second medium a mirror in response to adjusting the surface coverage of the nanoparticles at said interface to be at least nearly one full monolayer. In the alternative or in addition, controlling the at least one optical property comprises rendering the interface between the first medium and the second medium a transparent interface in response to adjusting the surface coverage of the nanoparticles at said interface to be nearly zero. Moreover, or as another alternative, such controlling comprises rendering the interface between the first medium and the second medium a filter in response to the surface coverage of the nanoparticles at said interface switching between approximately zero and at least nearly one monolayer. In certain embodiments of the subject disclosure, rendering the interface between the first medium and the second medium a mirror can be accomplished, or effected, in at most approximately one second. Furthermore, in embodiments in which the plurality of nanoparticles are magnetic nanoparticles, the controlling in act 1030 can comprise enabling or providing Faraday rotation of the optical polarization of light incident normal to the interface between the first medium and the second medium and propagating through such interface.

While methods and systems have been described in connection with illustrative embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout the subject application, various publications may be referenced. The disclosures of these publications in their entireties are hereby incorporated herein by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as illustrative only, with a true scope and spirit being indicated by the following claims.

What is claimed is:

1. A system, comprising:
a first medium;
a second medium that forms at least one interface with the first medium, wherein the first medium and the second medium are immiscible media; and
a control platform that controls the optical properties of the at least one interface through regulation of surface coverage of nanoparticles at the at least one interface, wherein a plurality of nanoparticles dispersed in at least one of the first medium or the second medium serves as a source of the nanoparticles at the at least one interface, and wherein
the control platform generates an electric potential difference across the at least one interface, and
based on the electric potential variance, the electric circuitry regulates the surface coverage of the nanoparticles.

2. The system of claim 1, wherein the first medium comprises an aqueous phase and the second medium comprises an oily phase.

3. The system of claim 2, wherein the oily phase comprises at least one of 1,2-dichloroethane or nitrobenzene.

4. The system of claim 2, wherein the aqueous phase contains an inorganic electrolyte, and wherein
the inorganic electrolyte comprises a salt which tends to dissolve in water, wherein for each ion in the salt, the free energy of transfer from the aqueous phase to the oily phase is at least about 0.1 eV.

5. The system of claim 4, wherein the oily phase contains one or more large organic ions, wherein the energy cost of transferring an ion of the one or more large organic ions from the oily phase to the aqueous phase is of substantially the same order of magnitude as the energy cost of transferring an ion in the inorganic electrolyte from the aqueous phase to the oily phase.

6. The system of claim 5, wherein the one or more large organic ions comprise at least one of tetralkylammonium⁺ or tetraphenylborate⁻.

7. The system of claim 1, wherein the electric potential variance is one of at most about one volt, or at least about one volt.

8. The system of claim 1, wherein at least one nanoparticle of the plurality of nanoparticles ranges in diameter from at least about 1 nm to about 500 nm.

9. The system of claim 1, wherein the first medium is a first electrolytic solution and the second medium is a second electrolytic solution, and wherein the first electrolytic solution and the second electrolytic solution are both substantially transparent to visible light.

10. The system of claim 1, wherein the surface coverage of the nanoparticles at the at least one interface switches between approximately zero coverage and a nearly full monolayer coverage in response to the electric potential variance, wherein
for the approximately zero coverage, the at least one interface behaves as a transparent interface, and
for the nearly full monolayer coverage, the at least one interface behaves as a mirror.

11. The system of claim 10, wherein in response to switching of the surface coverage of the nanoparticles at the at least one interface between the approximately zero coverage and the nearly full monolayer coverage in response to the potential variance, the at least one interface behaves as a light filter.

12. The system of claim 11, wherein the nanoparticle surface coverage switches between the approximately zero coverage and the nearly full monolayer coverage in at most approximately one second.

13. The system of claim 1, wherein the plurality of nanoparticles comprises at least one of symmetric nanoparticles or asymmetric nanoparticles, wherein the symmetric nanoparticles comprise a group of spherical nanoparticles.

14. The system of claim 13, wherein the plurality of nanoparticles further comprises non-magnetic nanoparticles and magnetic nanoparticles.

15. The system of claim 1, the magnetic nanoparticles enable magneto-optical manipulation of light polarization.

16. A method, comprising:
adjusting surface coverage of nanoparticles at an interface between a first medium and a second medium, wherein
the first medium and the second medium are immiscible media, and
a plurality of nanoparticles dispersed in at least one of the first medium or the second medium is a source of the nanoparticles at the interface between the first medium and the second medium; and
controlling at least one optical property of the interface between the first medium and the second medium in response to the adjusting.

17. The method of claim 16, further comprising:
producing the interface between the first medium and the second medium, wherein the first medium is a first electrolytic solution and the second medium is a second electrolytic solution, and wherein
the first electrolytic solution is (i) an aqueous phase comprising inorganic ions and (ii) substantially transparent to visible light, and
the second electrolytic solution is (I) an oily phase comprising organic ions and (II) substantially transparent to visible light.

18. The method of claim 16, wherein the adjusting comprises applying an electric potential difference between the first medium and the second medium, and wherein the applying comprises:
maintaining the electric potential difference below about one volt; or
maintaining the electric potential difference above or at about one volt.

19. The method of claim 18, wherein the controlling comprises:
rendering the interface between the first medium and the second medium a mirror in response to adjusting the surface coverage of the nanoparticles at said interface to be at least nearly one full monolayer.

20. The method of claim 18, wherein the controlling comprises:
rendering the interface between the first medium and the second medium a transparent interface in response to adjusting the surface coverage of the nanoparticles at said interface to be nearly zero.

21. The method of claim 18, wherein the controlling comprises:
rendering the interface between the first medium and the second medium a filter in response to the surface coverage of the nanoparticles at said interface switching between nearly zero and at least nearly one full monolayer.

22. The method of claim 19, wherein the rendering comprises rendering the interface between the first medium and the second medium a mirror in at most approximately one second.

23. The method of claim 16, wherein the controlling comprises:
providing Faraday rotation of the optical polarization of light incident normal to the interface between the first medium and the second medium and propagating through the interface.

24. An apparatus, comprising:
means for forming an interface between a first medium and a second medium, wherein the first medium and the second medium are immiscible media; and
means for controlling the optical properties of the interface between the first medium and the second medium, wherein the means for controlling comprises means for adjusting a concentration of nanoparticles at the interface amongst the first medium and the second medium.

25. The apparatus of claim 24, wherein:
the first medium is a first electrolytic solution and the second medium is a second electrolytic solution, wherein the first electrolytic solution and the second electrolytic solution are both substantially transparent to visible electromagnetic radiation; and
the interface between the first medium and the second medium is an interface between two immiscible electrolytic solutions (ITIES).

26. The apparatus of claim 24, wherein the means for adjusting comprises means for applying an electric potential difference between the first medium and the second medium and across the interface.
